(19) United States
(12) Patent Application Publication
(10) Pub. No.: US 2007/0213204 A1
(43) Pub. Date: Sep. 13, 2007

(54) Ziegler-Natta catalyst with in situ-generated donor

(75) Inventor: Douglas D. Klendworth, West Chester, OH (US)

Correspondence Address: DILWORTH & BARRESE, LLP, 333 EARLE OVINGTON BLVD., SUITE 702, UNIONDALE, NY, 11553, US

(73) Assignee: Novolen Technology Holdings C.V.

(21) Appl. No.: 11/373,003

(22) Filed: Mar. 10, 2006

(51) Int. Cl. C08F 4/02; C08F 4/44

(52) U.S. Cl. 502/103; 526/124.3; 526/125.3; 526/128; 502/125

(57) ABSTRACT

In one aspect, the invention relates to a method for producing a polymerization catalyst, the method comprising: (a) providing a catalyst support material comprising a magnesium component bound or complexed to a metal oxide component, the magnesium component being either a magnesium(Y) component wherein Y is an alkoxide group or amido group, or an alcohol-adducted magnesium halide component; (b) reacting the magnesium component with one or more silane halide compounds to provide a modified catalyst support material containing in situ-generated alkoxysilane or amidosilane electron donor compounds; (c) combining the modified catalyst support material with one or more catalytically active transition metal compounds to provide a catalyst precursor; and d) combining the catalyst precursor with one or more catalytically active main group metal compounds. In another aspect, the invention relates to a method for polymerizing one or a combination of olefins by contacting the one or combination of olefins with the above polymerization catalyst under polymerization conditions.

### FIELD OF THE INVENTION

The present invention relates to methods for producing polymerization catalysts, particularly Ziegler-Natta catalysts, as well as methods for using these catalysts in polymerization reactions.

### BACKGROUND OF THE INVENTION

Ziegler-Natta catalysts are well known for their use in producing stereoregulated linear polymers from 1-alkene monomers. Some examples of stereoregulated linear polymers produced with the aid of Ziegler-Natta catalysts include linear unbranched polyethylene and isotacetic and syndiotactic forms of polypropylene.

Typically, such catalysts include a trialkyl aluminum (e.g., triethyl aluminum) in combination with a catalytically active transition metal compound on a support. The support is typically a porous particulate support (e.g., silica or alumina) and a magnesium halide (e.g., MgCl₂). Generally, the Ziegler-Natta catalysts are small, solid particles, but soluble forms and supported catalysts have also been used.

The most commonly used transition metals include titanium and vanadium, most commonly as their TiCl₄, TiCl₃, VCl₄, and VCl₃ complexes. One of the most preferred Ziegler-Natta catalysts has been titanium tetrachloride combined with triethylaluminum in a hydrocarbon solution. The titanium-aluminum catalysts are most suited for producing isotacetic polymers while the vanadium-aluminum catalysts are most suited for producing syndiotactic polymers.

It is known that the activity and/or stereospecificity of Ziegler-Natta catalysts can be modified or improved by adding to the catalysts certain Lewis bases, also known as internal electron donors. Accordingly, Ziegler Natta polymerization catalysts nowadays typically include one or more internal electron donor compounds. See, for example, U.S. Pat. No. 4,107,414 to Giannini et al. Some typical electron donors include, for example, the classes of di-n-alkylphthalates and dialklyldialkoxysilanes.

The addition of an internal electron donor typically requires the subsequent addition of an external electron donor compound. The external electron donor compound is added during the course of the polymerization reaction.

The current need for adding appreciable quantities of electron donor compounds to the Ziegler-Natta catalyst presents a significant inconvenience. For example, the addition of electron donor compounds represents one or more additional steps in a commercial process. These additional process steps cause greater processing time as well as additional complication in process design.

Accordingly, there is a need for a method for producing such a polymerization catalyst wherein the benefits of an electron donor is provided but wherein the step of adding the electron donor is eliminated.

### SUMMARY OF THE INVENTION

These and other objectives, as will be apparent to those of ordinary skill in the art, have been achieved by providing a method for producing a polymerization catalyst containing one or more internal electron donor compounds generated in situ during production of the catalyst. The method comprises:

(a) providing a catalyst support material comprising a magnesium component bound or complexed to a metal oxide component, the magnesium component being either a magnesium(Y) component wherein Y is an alkoxide group or amido group, or an alcohol-adducted magnesium halide component, provided that when the magnesium component is the magnesium(Y) component then any magnesium halide component is excluded from the catalyst support material, and when the magnesium component is the alcohol-adducted magnesium halide component then a magnesium(Y) component and any organomagnesium component are excluded from the catalyst support material;

(b) reacting the magnesium component with one or more silane halide compounds to provide a modified catalyst support material by either:
(i) reacting the magnesium(Y) component with one or more silane halide compounds capable of converting the magnesium(Y) component to a magnesium halide component and capable of being converted to either one or more alkoxysilane electron donor compounds when Y is an alkoxide group or to one or more amidosilane electron donor compounds when Y is an amido group, or
(ii) reacting the alcohol-adducted magnesium halide component with one or more silane halide compounds capable of reacting with the adducted alcohol to form one or more alkoxysilane electron donor compounds,
   wherein the modified catalyst support material comprises the one or more alkoxysilane electron donor compounds or the one or more amidosilane electron donor compounds and a magnesium halide component bound or complexed to the metal oxide component;

(c) combining the modified catalyst support material of step (b) with one or more catalytically active transition metal compounds to provide a catalyst precursor; and

(d) combining the catalyst precursor with one or more catalytically active main group metal compounds, thereby producing the polymerization catalyst.

The invention further includes methods for using these catalysts in polymerization reactions. In particular, the invention includes a method for polymerizing one or more olefins using the above polymerization catalyst by contacting the catalyst with the one or more olefins under polymerization conditions.

The present invention advantageously simplifies the catalytic polymerization process by removing the internal electron donor addition step. In addition, the invention may allow the external electron donor addition step to be minimized or removed. Furthermore, the invention may allow for the enhancement of catalytic activity by providing a more disordered structure to the magnesium halide support.

### DETAILED DESCRIPTION OF PREFERRED EMBODIMENTS

In one aspect, the invention relates to a method for producing a polymerization catalyst. The invention first requires a catalyst support material which includes, minimally, a magnesium component bound or complexed to a metal oxide component. Typically, when the magnesium component is “bound” to the metal oxide component, a magnesium atom in the magnesium component is engaged in a covalent bond with an oxygen atom of the metal oxide component. When the magnesium component is “complexed” to the metal oxide component, the magnesium component is attached to the metal oxide component by other than covalent means, e.g., by van der Waals forces, hydrogen bonding, or other associative means.

In one embodiment, the magnesium component is a magnesium(Y) component. When the magnesium component is a magnesium(Y) component, the catalyst support material excludes any magnesium halide component from the catalyst support material prior to reacting the magnesium(Y) component with a silane halide compound.

In the magnesium(Y) component, Y is preferably an alkoxide group or an amido group. The catalyst support material can be succinctly represented as Mg(Y)-MO where MO represents a “metal oxide” and where “Mg(Y)—” represents a minimum structural criterion of the magnesium(Y) component which is bound or complexed to the metal oxide component. For example, “Mg(Y)” may literally represent a formula of the magnesium component when the magnesium is engaged in a covalent bond to the metal oxide. Alternatively, “Mg(Y)” may represent, inter alia, Mg(Y)₂ or Mg(Y)(alkyl) when “Mg(Y)” is not engaged in a covalent bond (i.e., is complexed) to the metal oxide.

An “alkoxide group” refers to a deprotonated alcohol group. An “amide group” refers to a deprotonated primary or secondary amino group. The alkoxide group or amido group (Y) in the magnesium(Y) component can be any suitable alkoxide group or amido group which does not interfere or adversely affect production of the catalyst or a polymerization reaction for which the catalyst is intended.

In this application, a “hydrocarbon group” refers to any chemical group composed of carbon and hydrogen atoms. Preferably, the hydrocarbon group contains a maximum of approximately fifty carbon atoms. More preferably, the hydrocarbon group contains a maximum of forty, more preferably thirty, more preferably twenty, more preferably ten, more preferably eight, and even more preferably six carbon atoms. The hydrocarbon group can be saturated, unsaturated, straight-chained, branched, cyclic, polycyclic, or fused.

In one embodiment, the hydrocarbon group is saturated. The saturated hydrocarbon group can be straight-chained, i.e., a straight-chained alkyl group. Some examples of suitable straight-chained alkyl groups include methyl, ethyl, propyl, butyl, pentyl, hexyl, octyl, decyl, dodecyl, hexadecyl, eicosyl, docosyl, and hexacosyl groups.

The saturated hydrocarbon group can alternatively be branched, i.e., a branched alkyl group. Some examples of branched alkyl groups include iso-propyl, iso-butyl, sec-butyl, t-butyl, iso-pentyl, neo-pentyl, 4-methylpentyl, 3-methylpentyl, 2-methylpentyl, 1-methylpentyl, 4,4-dimethylpentyl, 3,4-dimethylpentyl, 3,3-dimethylhexyl, and 2,2,4,4-tetramethylpentyl groups.

The hydrocarbon group can alternatively be saturated and cyclic, i.e., a cycloalkyl group. Some examples of cycloalkyl groups include cyclopropyl, cyclobutyl, cyclopentyl, cyclohexyl, cycloheptyl, cyclooctyl, methylcyclopropyl, 2,2-dimethylcyclopropyl, 2,3-dimethylcyclopropyl, 3-methylcyclobutyl, 2,4-dimethylcyclobutyl, 3,3-dimethylcyclobutyl, 3,4-dimethylcyclopentyl, 2-methylcyclohexyl, 3-methylcyclohexyl, 4-methylcyclohexyl, 2,6-dimethylcyclohexyl, and 2,4,6-trimethylcyclohexyl groups.

In another embodiment, the hydrocarbon group is unsaturated. An unsaturated hydrocarbon group can include one or more double and/or triple bonds. The unsaturated hydrocarbon group can be, for example, a straight-chained alkenyl group. Some examples of straight-chained alkenyl groups include vinyl (—CH═CH₂), 2-propenyl (—CH—CH═CH₂), 1-propenyl (—CH═CH—CH₃), 1-butenyl, 2-butenyl, 3-butenyl, 1,3-dibutenyl, 2-pentenyl, 2,4-dipentenyl, 5-hexenyl, 3,5-dihexenyl, and 1,3,5-trihexenyl groups. Some examples of straight-chained alkynyl groups include propargyl (—CH₂—C≡CH), 2-butynyl, and 3-butynyl groups.

The hydrocarbon group can alternatively be unsaturated and branched, i.e., a branched alkenyl group. Some examples of branched alkenyl groups include 2-methyl-1-propenyl, 1,2-dimethyl-1-propenyl, 2-methyl-2-propenyl, 1,2-dimethyl-2-propenyl, 3-methyl-2-butenyl, 2,3-dimethyl-2-butenyl, 2-methyl-1,3-dibutenyl, 2,3-dimethyl-1,3-dibutenyl, and 2-methyl-1,3,5-trihexenyl groups.

The hydrocarbon group can alternatively be unsaturated and cyclic, i.e., a cycloalkenyl group. Some examples of cycloalkenyl groups include 1-cyclopentenyl, 2-cyclopentenyl, 2-methyl-2-cyclopentenyl, 2,3-dimethyl-2-cyclopentenyl, 1-cyclohexenyl, 2-cyclohexenyl, 2-methyl-2-cyclohexenyl, 2,3-dimethyl-2-cyclohexenyl, 3-cyclohexenyl, 1,3-cyclohexadienyl, 2,5-cyclohexadienyl, 4-methyl-2,5-cyclohexadienyl, 2-methyl-2,5-cyclohexadienyl, and 2,3,5,6-tetramethyl-2,5-cyclohexadienyl groups.

The unsaturated cyclic hydrocarbon group can, in addition, be aromatic, i.e., an aryl group. Some preferred aryl groups include phenyl, tolyl, and xylyl groups.

In the exemplified hydrocarbon groups above, the “yl” ending implies “1-yl” wherein the 1-yl position is the position assumed to be occupied by a bond from the hydrocarbon group to an atom, molecule, or material of interest. The numbering of substituent groups in the exemplified hydrocarbon groups are numbered from the 1-yl position, i.e., from the point of bonding to an atom, molecule or material of interest. Accordingly, a 2-cyclopentenyl group differs from a 3-cyclopentenyl group in that in the former, the group's 1-yl linked position is one carbon atom away from the double bond, and in the latter, the group's 1-yl linked position is two carbon atoms away from the double bond.

The hydrocarbon groups described thus far are composed solely of carbon and hydrogen, and thus, can be said to be non-derivatized with heteroatoms. The invention includes, however, that the hydrocarbon groups can be derivatized with one or more heteroatoms, unless otherwise specified. A hydrocarbon group can be derivatized with one or more heteroatoms by having one or more heteroatoms, where possible, replacing one or more carbon or hydrogen atoms in the hydrocarbon group. Alternatively, or in addition, a hydrocarbon group can be derivatized with one or more heteroatoms by having one or more heteroatoms interrupt the carbon chain in the hydrocarbon group. Some preferred heteroatoms include oxygen, nitrogen, sulfur, and halogen atoms.

Some examples of heteroatom-substituted alkyl groups suitable as hydrocarbon groups include methoxymethyl (—CH₂—O—CH₃), 2-hydroxyethyl (—CH₂CH₂—OH), 2-methoxyethyl, 2-ethoxyethyl, 2-(2-ethoxylethyloxy)ethyl, 2,2,2-trifluoroethyl, 1,1,2,2,2-pentafluoroethyl, 3-chloropropyl, 2-chloro-2-propenyl, 3-bromopropyl, 2-aminoethyl (—CH₂CH₂—NH₂), and dimethylaminomethyl (—CH₂—N(CH₃)₂) groups. Some examples of heteroaryl groups suitable as hydrocarbon groups include pyridinyl, pyrimidinyl, triazinyl, imidazolyl, pyrrolyl, furanyl, thiopheneyl, oxazoyl, and thiazolyl groups.

In addition, any of the hydrocarbon rings described above can be fused to one or more other rings to form a fused ring system, i.e., a fused hydrocarbon group. Some examples of cycloalkyl rings fused to other cycloalkyl rings include decalinyl, bicyclo[3.3.0]octanyl, bicyclo[4.3.0]nonyl, and bicyclo[4.2.0]octanyl groups. Some examples of aryl rings fused to other aryl rings include naphthyl, phenanthryl, anthracenyl, triphenylenyl, and chrysenyl groups. Some examples of fused ring groups containing one or more heteroatoms include purinyl, naphthyridinyl, quinolinyl, benzimidazolyl, and phenanthrolinyl groups.

The hydrocarbon group can also be a polycyclic hydrocarbon group. Some examples of polycyclic hydrocarbon groups include bicyclo[2.2.1]heptanyl, bicyclo[2.2.1]hept-2-phenyl(norbornenyl), bicyclo[2.2.1]hepta-2,5-dienyl(norbornadienyl), bicyclo[2.2.2]octanyl, and 1,4-diazabicyclo[2.2.2]octanyl groups.

When Y is an alkoxide group, the magnesium(Y) component can be conveniently represented according to the formula —Mg(OR^{a}) wherein R^{a} represents any of the hydrocarbon groups described above. More preferably, R^{a} represents any of the hydrocarbon groups described above and having one to ten carbon atoms. Even more preferably, R^{a} is a methyl, ethyl, n-propyl, or iso-propyl group.

Some examples of suitable alkoxide groups for Y include methoxide, ethoxide, 1-propoxide, isopropoxide, 1-butoxide, iso-butoxide, tert-butoxide, sec-butoxide, 1-pentoxide, iso-pentoxide, neo-pentoxide, 2-pentoxide, 3-pentoxide, 1-hexoxide, 2-hexoxide, 3-hexoxide, 1-heptoxide, 2-heptoxide, 3-heptoxide, 4-heptoxide, 2-ethylhexoxide, 1-octoxide, 2-octoxide, 3-octoxide, 4-octoxide, phenoxide, 2-methylphenoxide, 2,6-dimethylphenoxide, 3,5-dimethylphenoxide, and 2,4,6-trimethylphenoxide.

When Y is an amido group, the magnesium(Y) component can be conveniently depicted according to the formula —Mg(NR^{c}R^{d}), wherein R^{c} and R^{d} each independently represents H or any of the saturated or unsaturated, straight-chained or branched, cyclic, polycyclic, or fused hydrocarbon groups described above. More preferably, R^{c} and R^{d} each independently represents H or any of the hydrocarbon groups described above having one to ten carbon atoms. Optionally, R^{c} and R^{d} can connect to form a nitrogen ring group.

Some examples of suitable amido groups (i.e., —NR^{c}R^{d} groups) for Y include dimethylamino, methylethylamino, diethylamino, n-propylmethylamino, di-(n-propyl)amino, n-butylmethylamino, di-(n-butyl)amino, sec-butylmethylamino, isobutylmethylamino, t-butylmethylamino, di-(sec-butyl)amino, di-(t-butyl)amino, phenyl(methyl)amino, phenyl(ethyl)amino, phenyl(n-propyl), phenyl(isopropyl)amino, phenyl(n-butyl)amino, phenyl(sec-butyl)amino, phenyl(isobutyl)amino, phenyl(t-butyl)amino, diphenylamino, benzyl(methyl)amino, benzyl(ethyl)amino, and dibenzylamino groups.

Some examples of suitable amido ring groups (i.e., wherein R^{c} and R^{d} are connected) include piperidine, piperazine, pyrrolidine, pyridine, pyrazine, imidazole, oxazole, and morpholine groups.

In another embodiment, the magnesium component bound or complexed to the metal oxide component is an alcohol-adducted magnesium halide component. The alcohol-adducted magnesium halide component can have any suitable number of alcohol molecules adducted per magnesium atom. The number of alcohol molecules per magnesium atom can also be an average number (e.g., 0.5, 1.5, 2.2, 2.5, and so on). When the magnesium component is an alcohol-adducted magnesium halide component, then a magnesium(Y) component, as described above, and any organomagnesium component, are excluded from the catalyst support material.

By “adducted” is meant that the alcohol molecules are not covalently bound to the magnesium halide component. The adducted alcohols are complexed, i.e., by any non-covalent association, with the magnesium halide component.

In a preferred embodiment, the alcohol-adducted magnesium halide component is represented according to the formula MgX₂.xR^{a}OH. In the formula, X represents a halogen atom and R^{a} represents any of the saturated or unsaturated, straight-chained or branched, cyclic, polycyclic, or fused hydrocarbon groups described above. R^{a} is more preferably any of these hydrocarbon groups having 1 to 10 carbon atoms. The coefficient x has a suitable value greater than zero. The coefficient x more preferably has a minimum value of about 1 and a maximum value of about 3. Even more preferably, x has a value of about 2.5.

The halide (X) in the magnesium halide component is any suitable halide including, for example, fluoride, chloride, bromide, and iodide. More preferably, the halide is chloride.

The adducted alcohol is any alcohol capable of reacting with a silane halide compound via an acid (HX) elimination pathway to form an alkoxysilane compound having a silicon-oxygen bond with the conjugate base of the alcohol. Some examples of particularly preferred alcohols include methanol, ethanol, 1-propanol, isopropanol, 1-butanol, iso-butanol, tert-butanol, sec-butanol, 1-pentanol, iso-pentanol, neo-pentanol, 2-pentanol, 3-pentanol, 1-hexanol, 2-hexanol, 3-hexanol, 1-heptanol, 2-heptanol, 3-heptanol, 4-heptanol, 2-ethylhexanol, 1-octanol, 2-octanol, 3-octanol, 4-octanol, cyclohexanol, phenol, 2-methylphenol, 2,6-dimethylphenol, 3,5-dimethylphenol, and 2,4,6-trimethylphenol.

The adducted alcohol can also include more than one hydroxy group. For example, the adducted alcohol can be a diol, triol, or polyol. Some examples of suitable diols include ethylene glycol, propylene glycol, and catechol. Some examples of suitable triols include glycerol, 1,2,3-heptanetriol, and 1,3,5-triazinetriol. The adducted alcohol can also be a combination of two or more alcohols.

The metal oxide component has a metal oxide composition which is compatible with the polymerization of olefins and with the conditions employed in the method of the present invention for producing the polymerization catalyst. More preferably, the metal oxide component is of a metal oxide composition commonly used in Ziegler-Natta catalysts.

Some examples of suitable metal oxide compositions for the metal oxide component include the main group metal oxides (e.g., oxides of silicon, aluminum, gallium, indium, germanium, and tin), the transition metal oxides (e.g., oxides of titanium, zirconium, vanadium, and niobium), the alkali and alkaline earth metal oxides (i.e., oxides of groups I or II of the Periodic Table), the rare earth metal oxides (i.e., lanthanide and actinide oxides), as well as any suitable combination or mixture thereof. Some examples of particularly preferred metal oxide compositions include aluminum oxide, aluminum phosphate, magnesium oxide, layered silicates, aluminum silicates, magnesium silicates, and combinations thereof. Particularly preferred is the use of silicon oxide, i.e., silica or silica gel (SiO₂).

The metal oxide component is preferably in the form of a particulate inorganic oxide, as commonly used in Ziegler-Natta catalysts. The particulate inorganic oxides preferably have a specific surface area in the range of from about 10 to about 1000 m²/g, more preferably of from about 50 to about 700 m²/g, and even more preferably from about 100 to about 600 m²/g, as determined in accordance with DIN 66131. The particulate inorganic oxides preferably have a mean particle diameter in the range of from about 5 to about 200 μm, more preferably from 10 to 100 μm, and even more preferably from 10 to 60 μm. Mean particle diameter herein refers to the volume average mean (median value) of the particle size distribution as determined by Malvern Mastersizer Analysis (Fraunhofer laser light scattering) in accordance with ASTM Standard D 4464-00.

The metal oxide component can be of a granular (irregular) or spray-dried (semispherical, micro-spheroidal) nature. Particularly preferred are silica gels derived from silicon hydrogels, e.g., by acidification of sodium silicate and optionally aged under suitable alkaline conditions.

The metal oxide can have pore volumes of any suitable size. Preferably, the pore size is from 0.1 to 10 cm³/g and more preferably from 1.0 to 4.0 cm³/g. These pore sizes can be measured or verified by mercury porosimetry in accordance with DIN 66133 and nitrogen adsorption in accordance with DIN 66131.

The pH value (i.e., the negative logarithm of the H⁺ ion concentration) of the metal oxide component may vary depending on the production process used. Preferably, the pH is in the range of from about 3.0 to about 9.0, and more preferably from about 5.0 to about 7.0. The pH value can be determined by using the method described in S. R. Morrison, The Chemical Physics of Surfaces, Plenum Press, New York [1977], pages 130 ff.

The metal oxide component typically contains hydroxyl groups on its surface. If desired, the hydroxyl group content can be reduced or even removed completely by using appropriate means. For example, the surface hydroxyl content can be reduced or removed by thermal or chemical treatment. A thermal treatment may comprise, for example, heating the oxide at temperatures of from about 250° C. to about 900° C., preferably from about 600° C. to about 800° C., for a period of from about 1 to about 24 hours, more preferably from about 2 to about 20 hours, and even more preferably from about 3 to about 12 hours. A chemical treatment may comprise, for example, treating the oxide with one or more Lewis acid reagents such as, for example, the halosilanes, haloboranes, aluminum halides, or aluminum alkyls. Preferably, the metal oxide component contains from 0.1 to 5% by weight physically adsorbed water. Usually the water content is determined by drying the inorganic oxide until constant weight at 160° C. and normal pressure. The loss of weight corresponds with the initial physically adsorbed water content.

The invention requires that the catalyst support material, as described above, be reacted with one or more suitable silane halide compounds to provide a modified catalyst support material. The modified catalyst support material includes one or more in situ-generated alkoxysilane or amidosilane electron donor compounds and a magnesium halide component bound or complexed to the metal oxide component.

The silane halide compounds are required to contain, minimally, at least one silicon-halide bond. When the catalyst support material includes a magnesium(Y) component, one or more suitable silane halide compounds must be capable of converting the magnesium(Y) component to a magnesium halide component, as well as capable of being converted to either one or more alkoxysilane electron donor compounds (when Y is an alkoxide group) or to one or more amidosilane electron donor compounds (when Y is an amido group) by reaction with the magnesium(Y) component. The conversion of the magnesium(Y) component to a magnesium halide component and the silane halide compound to either an alkoxysilane or amidosilane electron donor compound occurs by exchange of a Y group in the magnesium(Y) component with a halide group in the silane halide compound. By the foregoing process, an internal electron donor compound (i.e., the alkoxysilane or amidosilane electron donor compound) is generated in situ.

For example, when the magnesium(Y) component is a magnesium(alkoxide) component, the silane halide compound reacts with the magnesium(alkoxide) component by converting it to a magnesium halide component while the silane halide compound is converted to an in situ-generated alkoxysilane electron donor compound. Alternatively, when the magnesium(Y) component is a magnesium(amide) component, the silane halide compound reacts with the magnesium(amide) component by converting it to a magnesium halide component while the silane halide compound is converted to an in situ-generated amidosilane electron donor compound. The above-described reaction can be conveniently shown by the following equation:
Mg(Y)-MO+—Si—X→Mg(X)-MO+—Si—Y

When the catalyst support material includes an alcohol-adducted magnesium halide component, one or more suitable silane halide compounds must be capable of reacting with the adducted alcohol, preferably in an acid elimination process, to form one or more in situ-generated alkoxysilane electron donor compounds. The acid elimination process produces a hydrogen halide byproduct. The above-described reaction can be conveniently shown by the following equation:
MgX₂.R^{a}OH+—Si—X→MgX₂-MO+—Si—OR^{a}+HX

The one or more silane halide compounds are preferably selected from the class of compounds represented by the following formula:
R¹ₘR²ₙR³ᵣSiX₄₋ₘ₋ₙ₋ᵣ (1)

In formula (1), R¹, R², and R³ each independently represents H, or any of the saturated or unsaturated, straight-chained or branched, cyclic, polycyclic, or fused, non-derivatized or heteroatom-derivatized hydrocarbon groups described above. Preferably, R¹, R², and R³ each independently represents any of the hydrocarbon groups described above and has approximately 1 to 10 carbon atoms.

X represents a halogen atom. Preferably, the halogen atoms are selected from chloride, bromide, and iodide. More preferably, the halogen atom is a chloride atom. The subscripts m, n, and r independently represent 0 or 1.

In one embodiment, the hydrocarbon groups of R¹, R², and R³ are not derivatized with heteroatoms, i.e., are “non-derivatized.” Some examples of preferred non-derivatized groups for R¹, R², and R³ include methyl, ethyl, n-propyl, n-butyl, and sec-butyl groups. Other preferred and bulkier groups for R¹, R², and R³ include t-butyl, cyclohexyl, phenyl, 2-methylphenyl, 4-methylphenyl, 2,6-dimethylphenyl, and 2,4,6-trimethylphenyl groups.

In another embodiment, the hydrocarbon groups of R¹, R², and R³ are derivatized with one or more heteroatoms. Particularly preferred derivatized groups for R¹, R², and R³ include all of the alkoxide and amido groups described above for Y. Some particularly preferred derivatized hydrocarbon groups of R¹, R², and R³ include methoxy, ethoxy, n-propoxy, isopropoxy, n-butoxy, isobutoxy, sec-butoxy, t-butoxy, dimethylamino, methylethylamino, diethylamino, n-propylmethylamino, di-(n-propyl)amino, n-butylmethylamino, di-(n-butyl)amino, sec-butylmethylamino, isobutylmethylamino, t-butylmethylamino, di-(sec-butyl)amino, and di-(t-butyl)amino groups.

Optionally, according to formula (1), when two or three of R¹, R², and R³ are hydrocarbon groups, two or three of the hydrocarbon groups can be connected to form a silicon-containing ring or polycyclic ring system. By “connected” is meant that a carbon-carbon bond between two carbon atoms (one carbon from each group), replaces two carbon-hydrogen bonds (one carbon-hydrogen bond from each group). Alternatively, a carbon-carbon double bond between two carbon atoms (one carbon from each group) can replace four carbon-hydrogen bonds (two carbon-hydrogen bonds from each group). In addition, the connecting atoms are not limited to carbon atoms. The connecting atoms can include any of the heteroatoms mentioned above.

For example, if R¹ and R² are methyl groups, the methyl groups can be connected to form a silacyclopropane ring system; if R¹ is a methyl group and R² is an ethyl group, these can be connected to form a silacyclobutane ring system; and if R¹ and R² are both ethyl groups, these can be connected to form a silacyclopentane ring system. Alternatively, for example, if R¹ and R² are ethyl groups and R³ is a propyl group, these three groups can be interconnected to form a 1-silabicyclo[2.2.2]octane polycyclic ring system.

In one embodiment of formula (1), the silane halide compound is according to the formula:
R¹SiCl₃ (2)

In formula (2), R¹ has already been defined above. Some examples of silane chloride compounds according to formula (2) include trichlorosilane (HSiCl₃), methyltrichlorosilane, (trifluoromethyl)trichlorosilane, ethyltrichlorosilane, n-propyltrichlorosilane, 3-chloropropyltrichlorosilane, isopropyltrichlorosilane, n-butyltrichlorosilane, iso-butyltrichlorosilane, sec-butyltrichlorosilane, t-butyltrichlorosilane, n-pentyltrichlorosilane, iso-pentyltrichlorosilane, neo-pentyltrichlorosilane, n-hexyltrichlorosilane, n-heptyltrichlorosilane, n-octyltrichlorosilane, n-nonyltrichlorosilane, n-decyltrichlorosilane, n-dodecyltrichlorosilane, n-hexadecyltrichlorosilane, n-octadecyltrichlorosilane, n-eicosyltrichlorosilane, n-tricosyltrichlorosilane, methoxytrichlorosilane, ethoxytrichlorsilane, (2-ethoxyethyl)trichlorosilane, n-propoxytrichlorosilane, iso-propoxytrichlorosilane, n-butoxytrichlorosilane, iso-butoxytrichlorosilane, phenoxytrichlorosilane, 2,6-dimethylphenoxytrichlorosilane, vinyltrichlorosilane, cyclobutyltrichlorosilane, cyclopentyltrichlorosilane, cyclohexyltrichlorosilane, 2-cyclohexenyltrichlorosilane, phenyltrichlorosilane, 4-methylphenyltrichlorosilane, 2,6-dimethylphenyltrichlorosilane, 3,5-dimethylphenyltrichlorosilane, 2,4,6-trimethylphenyltrichlorosilane, 4-methoxyphenyltrichlorosilane, 2,6-dichlorophenyltrichlorosilane, pentafluorophenyltrichlorosilane, and benzyltrichlorosilane.

In another embodiment of formula (1), the silane halide compound is according to the formula:
R¹R²SiCl₂ (3)

In formula (3), R¹ and R² have already been defined above. Some examples of silane chloride compounds according to formula (3) include dimethyldichlorosilane, methylethyldichlorosilane, diethyldichlorosilane, methyl(n-propyl)dichlorosilane, ethyl(n-propyl)dichlorosilane, di(n-propyl)dichlorosilane, methyl(isopropyl)dichlorosilane, ethyl(isopropyl)dichlorosilane, diisopropyldichlorosilane, (n-butyl)methyldichlorosilane, (n-butyl)ethyldichlorosilane, (n-butyl)propyldichlorosilane, (n-butyl)isopropyldichlorosilane, di(n-butyl)dichlorosilane, isobutylmethyldichlorosilane, isobutylethyldichlorosilane, isobutyl(n-propyl)dichlorosilane, isobutylisopropyldichlorosilane, diisobutyldichlorosilane, (t-butyl)methyldichlorosilane, (t-butyl)ethyldichlorosilane, (t-butyl)(n-propyl)dichlorosilane, (t-butyl)(isopropyl)dichlorosilane, di(t-butyl)dichlorosilane, methyl(cyclohexyl)dichlorosilane, ethyl(cyclohexyl)dichlorosilane, n-propyl(cyclohexyl)dichlorosilane, isopropyl(cyclohexyl)dichlorosilane, n-butyl(cyclohexyl)dichlorosilane, isobutyl(cyclohexyl)dichlorosilane, t-butyl(cyclohexyl)dichlorosilane, dicyclohexyldichlorosilane, methyl(cyclopentyl)dichlorosilane, ethyl(cyclopentyl)dichlorosilane, n-propyl(cyclopentyl)dichlorosilane, isopropyl(cyclopentyl)dichlorosilane, n-butyl(cyclopentyl)dichlorosilane, isobutyl(cyclopentyl)dichlorosilane, t-butyl(cyclopentyl)dichlorosilane, dicyclopentyldichlorosilane, methyl(phenyl)dichlorosilane, ethyl(phenyl)dichlorosilane, n-propyl(phenyl)dichlorosilane, isopropyl(phenyl)dichlorosilane, n-butyl(phenyl)dichlorosilane, isobutyl(phenyl)dichlorosilane, cyclohexyl(phenyl)dichlorosilane, diphenyldichlorosilane, methyl(p-tolyl)dichlorosilane, di(p-tolyl)dichlorosilane, and cyclotrimethylenedichlorosilane.

Other less preferred silane halide compounds according to formula (3) include methyldichlorosilane (CH₃SiHCl₂), ethyldichlorosilane, n-propyldichlorosilane, isopropyldichlorosilane, vinyldichlorosilane, vinylmethyldichlorosilane, methoxydichlorosilane, dimethoxydichlorosilane, ethoxydichlorosilane, diethoxydichlorosilane, di(n-propoxy)dichlorosilane, diisopropoxydichlorosilane, methylmethoxydichlorosilane, methylethoxydichlorosilane, ethylmethoxydichlorosilane, 2-chloroethyl(methyl)dichlorosilane, 2-chloroethyl(methoxy)dichlorosilane, (isopropoxy)methyldichlorosilane, phenylmethoxydichlorosilane, methylphenoxydichlorosilane, diphenoxydichlorosilane, dicyclohexoxydichlorosilane, cyclohexoxymethyldichlorosilane and cyclohexoxymethoxydichlorosilane.

In yet another embodiment of formula (1), the silane halide compound is according to the formula:
R¹R²R³SiCl (4)

In formula (4), R¹, R² and R³ have already been defined above. Some examples of silane chloride compounds according to formula (4) include trimethylchlorosilane, ethyldimethylchlorosilane, methyldiethylchlorosilane, triethylchlorosilane, tri(n-propyl)chlorosilane, di(n-propyl)methylchlorosilane, n-propyldimethylchlorosilane, triisopropylchlorosilane, di(isopropyl)methylchlorosilane, isopropyldimethylchlorosilane, tri(n-butyl)chlorosilane, di(n-butyl)methylchlorosilane, n-butyldimethylchlorosilane, triisobutylchlorosilane, diisobutylmethylchlorosilane, isobutyldimethylchlorosilane, t-butyldimethylchlorosilane, t-butyldiethylchlorosilane, di(t-butyl)methylchlorosilane, tri-(t-butyl)chlorosilane, triphenylchlorosilane, vinyldimethylchlorosilane, divinylmethylchlorosilane, trivinylchlorosilane, allyldimethylchlorosilane, methyldiphenylchlorosilane, ethyldiphenylchlorosilane, n-propyldiphenylchlorosilane, isopropyldiphenylchlorosilane, n-butyldiphenylchlorosilane, t-butyldiphenylchlorosilane, isobutyldiphenylchlorosilane, benzyldimethylchlorosilane, tricyclohexylchlorosilane, dicyclohexylmethylchlorosilane, dicyclohexylethylchlorosilane, dicyclohexyl(n-propyl)chlorosilane, dicyclohexylisopropylchlorosilane, dicyclohexyl(n-butyl)chlorosilane, dicyclohexylisobutylchlorosilane, cyclohexyldimethylchlorosilane, tricyclopentylchlorosilane, dicyclopentylmethylchlorosilane, dicyclopentylethylchlorosilane, dicyclopentyl(n-propyl)chlorosilane, dicyclopentylisopropylchlorosilane, dicyclopentyl(n-butyl)chlorosilane, dicyclopentylisobutylchlorosilane, cyclopentyldimethylchlorosilane, p-tolyldimethylchlorosilane, p-tolyldiethylchlorosilane, di(p-tolyl)methylchlorosilane, di(p-tolyl)ethylchlorosilane, tris-(p-tolyl)chlorosilane, and cyclotrimethylenemethylchlorosilane.

Other less preferred silane halide compounds according to formula (4) include chlorosilane (SiClH₃), methylchlorosilane, dimethylchlorosilane, diethylchlorosilane, di-(n-propyl)chlorosilane, diisopropylchlorosilane, di-(t-butyl)chlorosilane, diphenylchlorosilane, vinylchlorosilane, divinylchlorosilane, vinylmethylchlorosilane, trimethoxychlorosilane, dimethoxychlorosilane, triethoxychlorosilane, diethoxychlorosilane, tri(n-propoxy)chlorosilane, triisopropoxychlorosilane, dimethylmethoxychlorosilane, dimethylethoxychlorosilane, ethyldimethoxychlorosilane, 2-chloroethyldimethylchlorosilane, 2-chloroethyldimethoxychlorosilane, (isopropoxy)dimethylchlorosilane, phenyldimethoxychlorosilane, methylphenoxychlorosilane, methyldiphenoxychlorosilane, dicyclohexoxymethylchlorosilane, cyclohexoxydimethylchlorosilane, cyclohexoxydimethoxychlorosilane, 3-allylphenylpropyldimethylchlorosilane, 2-(bicycloheptyl)dimethylchlorosilane, bis(chloromethyl)methylchlorosilane, chloromethyldimethylchlorosilane, bromomethyldimethylchlorosilane, 3-chloropropyldimethylchlorosilane, 4-chlorobutyldimethylchlorosilane, p-(t-butyl)phenethyldimethylchlorosilane, 3-cyanopropyldimethylchlorosilane, n-pentyldimethylchlorosilane, n-hexyldimethylchlorosilane, n-heptyldimethylchlorosilane, n-octyldimethylchlorosilane, n-nonyldimethylchlorosilane, n-decyldimethylchlorosilane, heptafluoropropyldimethylchlorosilane, and pentafluorophenyldimethylchlorosilane.

In yet another embodiment of formula (1), the silane halide compound is tetrachlorosilane (SiCl₄).

Some examples of silicon-containing ring compounds suitable as silane halide compounds according to formula (1) include 1-chloro-1-methylsilacyclobutane, 1-chloro-1-phenylsilacyclobutane, 1,1-dichlorosilacyclobutane, and 1-chloro-1-methylsilacyclooctane. An example of a silicon-containing polycyclic ring compound suitable as a silane halide compound according to formula (1) includes 1-chloro-1-silabicyclo[2.2.2]octane.

The silane halide compounds considered thus far according to formula (1) contain a single silicon atom, and are therefore, in the class of monosilanes. However, the silane halide compound is not limited to monosilane compounds. The silane halide compound may contain any suitable number of silicon atoms. For example, the silane halide compound may be a disilane, trisilane, tetrasilane, or a siloxane.

Some examples of suitable disilane halide compounds include 1,2-bis-(trichlorosilyl)ethane, 1,3-bis-(trichlorosilyl)propane, 1,4-bis-(trichlorosilyl)butane, 1,4-bis-(trichlorosilyl)-2-butene, 1,2-bis-(methyldichlorosilyl)ethane, 1,2-bis-(dimethylchlorosilyl)ethane, 1,3-bis-(dimethylchlorosilyl)propane, 1-trichlorosilyl-2-trimethylsilylethane, 1-trichlorosilyl-2-trimethoxysilylethane, 1-methyldichlorosilyl-3-methoxydimethylsilylpropane, 1,3-bis-(trichlorosilyl)-2-methylpropane, 1,4-bis-(trichlorosilyl)benzene, 1,3-bis-(dichloromethylsilyl)benzene, 1,4-bis-(dichloromethylsilyl)benzene, 1,3-bis-(dimethylchlorosilyl)benzene, 1,4-bis-(dimethylchlorosilyl)benzene, and 1-trichlorosilyl-4-(trichlorosilylmethyl)benzene.

Some examples of suitable trisilane halide compounds include bis-(trichlorosilylethyl)dimethylsilane, bis-(dichloromethylsilylethyl)dimethylsilane, and bis-(chlorodimethylsilylethyl)dimethylsilane. Some examples of suitable tetrasilane halide compound include tris-(trichlorosilylethyl)methylsilane, tris-(dichloromethylsilylethyl)methylsilane, tris-(chlorodimethylsilylethyl)methylsilane, and bis-1,2-(2-trichlorosilylethyldimethylsilyl)ethane. Some examples of suitable siloxane compounds include hexachlorodisiloxane, octachlorotrisiloxane, decachlorotetrasiloxane, and hexachlorocyclotrisiloxane.

By reacting one or more silane halide compounds with the magnesium component, one or more alkoxysilane or amidosilane electron donor compounds are generated in situ. The in situ-generated silane electron donor compounds contain, minimally, a silicon atom bound to a Y group.

The composition of the silane electron donor compound depends on the composition of the starting silane halide compound, as well as other reaction conditions, such as, for example, the relative amounts of silane halide to magnesium, and such other factors as reaction temperature, pressure, and time. Some representative reaction schemes are given below. The reaction schemes are provided to demonstrate how the composition of the in situ-generated electron donor compounds can vary according to the stoichiometric ratio of the reactants. The reaction schemes are not meant to indicate that the products are formed in defined ratios or defined quantities according to the amounts of reactants, nor are they meant to indicate that the exemplary products shown are the only products formed. Accordingly, the reaction schemes have not been balanced.
Mg(Y)-MO+SiCl₄→MgCl₂.MO+YSiCl₃
Mg(Y)-MO+½SiCl₄→MgCl₂.MO+Y₂SiCl₂
Mg(Y)-MO+R₂SiCl₂→MgCl₂.MO+YR₂SiCl
Mg(Y)-MO+½R₂SiCl₂→MgCl₂.MO+Y₂SiR₂
Mg(Y)-MO+R₃SiCl→MgCl₂.MO+YR₃Si

In the representative reaction schemes given above, Y is an alkoxide or amido group, as described earlier, and the R groups represent any of the hydrocarbon groups described above. As discussed earlier, the R groups in the starting silane halide can also be any of the alkoxide or amido groups described above for Y. Accordingly, it is possible for the silane halide reaction to generate a trialkoxysilane or tetraalkoxysilane electron donor compound from a dihalosilane or monohalosilane starting compound:
Mg(Y)-MO+Y₂SiCl₂→MgCl₂.MO+Y₃SiCl
Mg(Y)-MO+½Y₂SiCl₂→MgCl₂.MO+Y₄Si
Mg(Y)-MO+Y₃SiCl→MgCl₂.MO+Y₄Si

In addition, where the starting silane halide compound contains a Y group, the resulting silane electron donor compound can have more than one kind of Y group. For example, if the starting silane halide compound contains an isopropoxide group and the magnesium component is Mg(methoxide) or MgCl₂.xMeOH, the resulting silane electron donor compound after reaction with the magnesium component will typically contain both isopropoxide and methoxide groups.

The one or more in situ-generated silane electron donor compounds can be conveniently represented according to the formula:
R⁴ₛR⁵ₜR⁶ᵤSi(Y)₄₋ₛ₋ₜ₋ᵤ (5)

In formula (5), R⁴, R⁵, and R⁶ each independently represent H, halide, or any of the saturated or unsaturated, straight-chained or branched, cyclic, polycyclic, or fused, derivatized or non-derivatized hydrocarbon groups described above. Optionally, when two or three of R⁴, R⁵, and R⁶ are hydrocarbon groups, two or three of the hydrocarbon groups are connected to form a silicon-containing ring or polycyclic ring system, as described for R¹, R², and R³ above. The group Y has been described above and includes the alkoxy (OR^{a}) and amido (NR^{c}R^{d}) groups described above. The subscripts s, t, and u independently represent 0 or 1. The halide group is preferably chloride, bromide, or iodide, and more preferably chloride.

In a preferred embodiment, the in situ-generated silane electron donor compound of formula (5) is an alkoxysilane electron donor compound of formula:
R⁴ₛR⁵ₜR⁶ᵤSi(OR^{a})₄₋ₛ₋ₜ₋ᵤ (5a)

In one embodiment, the one or more in situ-generated alkoxysilane electron donor compounds of formula (5a) are according to the formula:
R^{a}OSiCl₃ (6)

Some examples of in situ-generated alkoxysilane electron donor compounds according to formula (6) include methoxytrichlorosilane, trifluoromethoxytrichlorosilane, ethoxytrichlorosilane, n-propoxytrichlorosilane, isopropoxytrichlorosilane, n-butoxytrichlorosilane, isobutoxytrichlorosilane, t-butoxytrichlorosilane, vinyloxytrichlorosilane, phenoxytrichlorosilane, 4-methylphenoxytrichlorosilane, 2,6-dimethylphenoxytrichlorosilane, 2,5-dimethylphenoxytrichlorosilane, 2,4,6-trimethylphenoxytrichlorosilane, cyclohexoxytrichlorosilane, and benzyloxytrichlorosilane.

In another embodiment, the in situ-generated alkoxysilane electron donor compounds of formula (5a) are according to the formula:
(R^{a}O)₂SiCl₂ (7)

Some examples of in situ-generated alkoxysilane electron donor compounds according to formula (7) include dimethoxydichlorosilane, methoxyethoxydichlorosilane, diethoxydichlorosilane, ethoxy(n-propoxy)dichlorosilane, di-(n-propoxy)dichlorosilane, diisopropoxydichlorosilane, n-butoxymethoxydichlorosilane, di-(n-butoxy)dichlorosilane, di-(isobutoxy)dichlorosilane, di-(t-butoxy)dichlorosilane, t-butoxymethoxydichlorosilane, t-butoxyethoxydichlorosilane, t-butoxyisopropoxydichlorosilane, diphenoxydichlorosilane, phenoxymethoxydichlorosilane, phenoxyethoxydichlorosilane, and phenoxyisopropoxydichlorosilane.

In another embodiment, the in situ-generated alkoxysilane electron donor compounds of formula (5a) are according to the formula:
R⁴R⁵Si(OR^{a})₂ (8)

In formula (8), R^{a}, R⁴, R⁵, and R^{a} are as described above. Preferably, R^{a}, R⁴ and R⁵ each independently represent any of the saturated or unsaturated, straight-chained or branched, or cyclic, polycyclic, or fused hydrocarbon groups described above and have 1 to 10 carbon atoms.

Some examples of in situ-generated alkoxysilane electron donor compounds according to formula (8) include dimethoxydimethylsilane, methoxyethoxydimethylsilane, dimethoxymethylethylsilane, dimethoxydiethylsilane, dimethoxydi(n-propyl)silane, dimethoxydiisopropyl)silane, dimethoxydi(n-butyl)silane, dimethoxydiisobutylsilane, dimethoxydi(sec-butyl)silane, dimethoxydi(t-butyl)silane, diethoxydi(isopropyl)silane, diethoxydi(t-butyl)silane, di(n-propoxy)dimethylsilane, di(n-propoxy)diethylsilane, diisopropoxydimethylsilane, diisopropoxydiethylsilane, diisopropoxydi(n-propyl)silane, diisopropoxydiisopropylsilane, diisopropoxydi(n-butyl)silane, diisopropoxydiisobutylsilane, diisopropoxydi(sec-butyl)silane, diisopropoxydi(t-butyl)silane, di(t-butoxy)dimethylsilane, di(t-butoxy)diethylsilane, di(t-butoxy)di(n-propyl)silane, di(t-butoxy)diisopropylsilane, di(t-butoxy)di(n-butyl)silane, di(t-butoxy)diisobutylsilane, di(t-butoxy)di(sec-butyl)silane, di(t-butoxy)di(t-butyl)silane, dimethoxydiphenylsilane, methoxyphenoxydimethylsilane, diethoxydiphenylsilane, dimethoxymethylphenylsilane, diphenoxydimethylsilane, diphenoxydiethylsilane, diphenoxydi(n-propyl)silane, diphenoxydiisopropoxysilane, diphenoxydi(n-butyl)silane, diphenoxydiisobutylsilane, diphenoxydi(t-butyl)silane, diphenoxydiphenylsilane, and dimethoxydivinylsilane.

In another embodiment, the in situ-generated alkoxysilane electron donor compounds of formula (5a) are according to the formula:
Si(OR^{a})₄ (9)

Some examples of in situ-generated alkoxysilane electron donor compounds according to formula (9) include tetramethoxysilane, tetraethoxysilane, tetra(n-propoxy)silane, tetra(isopropoxy)silane, tetra(n-butoxy)silane, tetra(isobutoxy)silane, tetra(sec-butoxy)silane, tetra(t-butoxy)silane, tetraphenoxysilane, ethoxytrimethoxysilane, diethoxydimethoxysilane, methoxytriethoxysilane, n-propoxytrimethoxysilane, isopropoxytrimethoxysilane, n-butoxytrimethoxysilane, isobutoxytrimethoxysilane, t-butoxytrimethoxysilane, di(n-propoxy)dimethoxysilane, diisopropoxydimethoxysilane, di(n-butoxy)dimethoxysilane, diisobutoxydimethoxysilane, di(t-butoxy)dimethoxysilane, tri(n-propoxy)methoxysilane, triisopropoxymethoxysilane, tri(n-butoxy)methoxysilane, triisobutoxymethoxysilane, tri(t-butoxy)methoxysilane, tri(n-propoxy)ethoxysilane, tri(n-propoxy)(t-butoxy)silane, triphenoxymethoxysilane, triphenoxyethoxysilane, triphenoxy(n-propoxy)silane, triphenoxyisopropoxysilane, triphenoxy(n-butoxy)silane, triphenoxyisobutoxysilane, triphenoxy(sec-butoxy)silane, triphenoxy(t-butoxy)silane, diphenoxydimethoxysilane, diphenoxydiethoxysilane, diphenoxydi(n-propoxy)silane, diphenoxydiisopropoxysilane, diphenoxydi(n-butoxy)silane, diphenoxydiisobutoxysilane, diphenoxydi(sec-butoxy)silane, diphenoxydi(t-butoxy)silane, trimethoxyphenoxysilane, triethoxyphenoxysilane, tri(n-propoxy)phenoxysilane, triisopropoxyphenoxysilane, tri(n-butoxy)phenoxysilane, triisobutoxyphenoxysilane, and vinyloxytrimethoxysilane.

In another embodiment, the in situ-generated alkoxysilane electron donor compounds of formula (5a) are according to the formula:
Si(OR^{a})₃Cl (10)

Some examples of in situ-generated alkoxysilane electron donor compounds according to formula (10) include trimethoxychlorosilane, triethoxychlorosilane, tri(n-propoxy)chlorosilane, triisopropoxychlorosilane, tri(n-butoxy)chlorosilane, tri(sec-butoxy)chlorosilane, tri(t-butoxy)chlorosilane, triisobutoxychlorosilane, tri(n-pentoxy)chlorosilane, triisopentoxychlorosilane, tri(neopentoxy)chlorosilane, tri(n-hexoxy)chlorosilane, tri(n-heptoxy)chlorosilane, tri(n-octoxy)chlorosilane, tri(n-nonoxy)chlorosilane, tri(n-decoxy)chlorosilane, triphenoxychlorosilane, tricyclohexoxychlorosilane, trivinyloxychlorosilane, ethoxydimethoxychlorosilane, n-propoxydimethoxychlorosilane, isopropoxydimethoxychlorosilane, diisopropoxyethoxychlorosilane, isopropoxydiethoxychlorosilane, di(n-butoxy)methoxychlorosilane, n-butoxydimethoxychlorosilane, t-butoxydimethoxychlorosilane, di(t-butoxy)dimethoxychlorosilane, phenoxydimethoxychlorosilane, phenoxydiethoxychlorosilane, phenoxydi(n-propoxy)chlorosilane, phenoxydiisopropoxychlorosilane, phenoxydi(n-butoxy)chlorosilane, phenoxydiisobutoxychlorosilane, phenoxydi(t-butoxy)chlorosilane, phenoxydicyclohexoxychlorosilane, methoxydiphenoxychlorosilane, ethoxydiphenoxychlorosilane, dicyclohexoxymethoxychlorosilane, dicyclohexoxyisopropoxychlorosilane, cyclohexoxydimethoxychlorosilane, cyclohexoxydiisobutoxychlorosilane, and cyclohexoxydi(t-butoxy)chlorosilane.

In another embodiment, the in situ-generated alkoxysilane electron donor compounds of formula (5a) are according to the formula:
Si(OR^{a})₃R^{a} (11)

Some examples of in situ-generated alkoxysilane electron donor compounds according to formula (11) include trimethoxymethylsilane, trimethoxyethylsilane, trimethoxy(n-propyl)silane, trimethoxyisopropylsilane, trimethoxy(n-butyl)silane, trimethoxyisobutylsilane, trimethoxy(sec-butyl)silane, trimethoxy(t-butyl)silane, trimethoxy(n-pentyl)silane, trimethoxyphenylsilane, trimethoxy(2-methylphenyl)silane, trimethoxy(2,6-dimethylphenyl)silane, trimethoxy(2,4,6-trimethylphenyl)silane, trimethoxycyclohexylsilane, triethoxymethylsilane, triethoxyethylsilane, triethoxy(n-propyl)silane, triethoxyisopropylsilane, triethoxy(n-butyl)silane, triethoxyisobutylsilane, triethoxy(sec-butyl)silane, triethoxy(t-butyl)silane, triethoxy(n-pentyl)silane, triethoxyphenylsilane, triethoxy(2-methylphenyl)silane, triethoxy(2,6-dimethylphenyl)silane, triethoxy(2,4,6-trimethylphenyl)silane, triethoxycyclohexylsilane, tri(n-propoxy)methylsilane, tri(n-propoxy)ethylsilane, tri(n-propoxy)(n-propyl)silane, tri(n-propoxy)isopropylsilane, tri(n-propoxy)(n-butyl)silane, tri(n-propoxy)isobutylsilane, tri(n-propoxy)(sec-butyl)silane, tri(n-propoxy)(t-butyl)silane, tri(n-propoxy)(n-pentyl)silane, tri(n-propoxy)phenylsilane, tri(n-propoxy)(2-methylphenyl)silane, tri(n-propoxy)(2,6-dimethylphenyl)silane, tri(n-propoxy)(2,4,6-trimethylphenyl)silane, tri(n-propoxy)cyclohexylsilane, triisopropoxymethylsilane, triisopropoxyethylsilane, triisopropoxy(n-propyl)silane, triisopropoxyisopropylsilane, triisopropoxy(n-butyl)silane, triisopropoxyisobutylsilane, triisopropoxy(sec-butyl)silane, triisopropoxy(t-butyl)silane, triisopropoxy(n-pentyl)silane, triisopropoxyphenylsilane, triisopropoxy(2-methylphenyl)silane, triisopropoxy(2,6-dimethylphenyl)silane, triisopropoxy(2,4,6-trimethylphenyl)silane, triisopropoxycyclohexylsilane, tri(n-butoxy)methylsilane, tri(n-butoxy)ethylsilane, tri(n-butoxy)(n-propyl)silane, tri(n-butoxy)isopropylsilane, tri(n-butoxy)(n-butyl)silane, tri(n-butoxy)isobutylsilane, tri(n-butoxy)(sec-butyl)silane, tri(n-butoxy)(t-butyl)silane, tri(n-butoxy)(n-pentyl)silane, tri(n-butoxy)phenylsilane, tri(n-butoxy)(2-methylphenyl)silane, tri(n-butoxy)(2,6-dimethylphenyl)silane, tri(n-butoxy)(2,4,6-trimethylphenyl)silane, tri(n-butoxy)cyclohexylsilane, triisobutoxymethylsilane, triisobutoxyethylsilane, triisobutoxy(n-propyl)silane, triisobutoxyisopropylsilane, triisobutoxy(n-butyl)silane, triisobutoxyisobutylsilane, triisobutoxy(sec-butyl)silane, triisobutoxy(t-butyl)silane, triisobutoxy(n-pentyl)silane, triisobutoxyphenylsilane, triisobutoxy(2-methylphenyl)silane, triisobutoxy(2,6-dimethylphenyl)silane, triisobutoxy(2,4,6-trimethylphenyl)silane, triisobutoxycyclohexylsilane, tri(t-butoxy)methylsilane, tri(t-butoxy)ethylsilane, tri(t-butoxy)(n-propyl)silane, tri(t-butoxy)isopropylsilane, tri(t-butoxy)(n-butyl)silane, tri(t-butoxy)isobutylsilane, tri(t-butoxy)(sec-butyl)silane, tri(t-butoxy)(t-butyl)silane, tri(t-butoxy)(n-pentyl)silane, tri(t-butoxy)phenylsilane, tri(t-butoxy)(2-methylphenyl)silane, tri(t-butoxy)(2,6-dimethylphenyl)silane, tri(t-butoxy)(2,4,6-trimethylphenyl)silane, tri(t-butoxy)cyclohexylsilane, tricyclohexoxymethylsilane, tricyclohexoxyethylsilane, tricyclohexoxy(n-propyl)silane, tricyclohexoxyisopropylsilane, tricyclohexoxy(n-butyl)silane, tricyclohexoxyisobutylsilane, tricyclohexoxy(sec-butyl)silane, tricyclohexoxy(t-butyl)silane, tricyclohexoxy(n-pentyl)silane, tricyclohexoxyphenylsilane, tricyclohexoxy(2-methylphenyl)silane, tricyclohexoxy(2,6-dimethylphenyl)silane, tricyclohexoxy(2,4,6-trimethylphenyl)silane, tricyclohexoxycyclohexylsilane, triphenoxymethylsilane, triphenoxyethylsilane, triphenoxy(n-propyl)silane, triphenoxyisopropylsilane, triphenoxy(n-butyl)silane, triphenoxyisobutylsilane, triphenoxy(sec-butyl)silane, triphenoxy(t-butyl)silane, triphenoxy(n-pentyl)silane, triphenoxyphenylsilane, triphenoxy(2-methylphenyl)silane, triphenoxy(2,6-dimethylphenyl)silane, triphenoxy(2,4,6-trimethylphenyl)silane, and triphenoxycyclohexylsilane.

In another embodiment, the one or more in situ-generated silane electron donor compounds of formula (5) are amidosilane electron donor compounds of formula:
R⁴ₛR⁵ₜR⁶ᵤSi(NR^{c}R^{d})₄₋ₛ₋ₜ₋ᵤ (5b)

In formula (5b), R^{a}, R⁴, R⁵, R^{c} and R^{d} are as described above. Some examples of in situ-generated amidosilane electron donor compounds according to formula (5b) include (CH₃)₃Si(NHCH₃), (C₂H₅)₃Si(NHCH₃), (n-C₃H₇)₃Si(NHCH₃), (iso-C₃H₇)₃Si(NHCH₃), (n-C₄H₉)₃Si(NHCH₃), (iso-C₄H₉)₃Si(NHCH₃), (tert-C₄H₉)₃Si(NHCH₃), (cyclohexyl)₃Si(NHCH₃), (phenyl)₃Si(NHCH₃), (CH₃)₂(CH₃CH₂)Si(NHCH₃), (CH₃)(C₂H₅)₂Si(NHCH₃), (CH₃)₂(iso-C₃H₇)Si(NHCH₃), (CH₃)(iso-C₄H₉)₂Si(NHCH₃), (CH₃)(tert-C₄H₉)₂Si(NHCH₃), (CH₃)₃Si(N(CH₃)₂), (C₂H₅)₃Si(N(CH₃)₂), (n-C₃H₇)₃Si(N(CH₃)₂), (iso-C₃H₇)₃Si(N(CH₃)₂), (n-C₄H₉)₃Si(N(CH₃)₂), (iso-C₄H₉)₃Si(N(CH₃)₂), (tert-C₄H₉)₃Si(N(CH₃)₂), (cyclohexyl)₃Si(N(CH₃)₂), (phenyl)₃Si(N(CH₃)₂), (CH₃)₂(CH₃CH₂)Si(N(CH₃)₂), (CH₃)(C₂H₅)₂Si(N(CH₃)₂), (CH₃)₂(iso-C₃H₇)Si(N(CH₃)₂), (CH₃)(iso-C₄H₉)₂Si(N(CH₃)₂), (CH₃)(tert-C₄H₉)₂Si(N(CH₃)₂), (CH₃)₃Si(N(iso-C₃H₇)₂), (C₂H₅)₃Si(N(iso-C₃H₇)₂), (n-C₃H₇)₃Si(N(iso-C₃H₇)₂), (iso-C₃H₇)₃Si(N(iso-C₃H₇)₂), (n-C₄H₉)₃Si(N(iso-C₃H₇)₂), (iso-C₄H₉)₃Si(N(iso-C₃H₇)₂), (tert-C₄H₉)₃Si(N(iso-C₃H₇)₂), (cyclohexyl)₃Si(N(iso-C₃H₇)₂), (phenyl)₃Si(N(iso-C₃H₇)₂), (CH₃)₂(CH₃CH₂)Si(N(iso-C₃H₇)₂), (CH₃)(C₂H₅)₂Si(N(iso-C₃H₇)₂), (CH₃)₂(iso-C₃H₇)Si(N(iso-C₃H₇)₂), (CH₃)(iso-C₄H₉)₂Si(N(iso-C₃H₇)₂), (CH₃)(tert-C₄H₉)₂Si(N(iso-C₃H₇)₂), (CH₃)₃Si(N(cyclohexyl)₂), (C₂H₅)₃Si(N(cyclohexyl)(CH₃)), Cl₃Si(N(CH₃)₂), Cl₃Si(N(C₂H₅)₂), Cl₃Si(N(iso-C₃H₇)₂), Cl₃Si(N(iso-C₄H₉)₂), Cl₃Si(N(tert-C₄H₉)₂), Cl₃Si(N(cyclohexyl)₂), Cl₃Si(N(cyclohexyl)(CH₃)), Cl₃Si(N(tert-C₄H₉)(CH₃)), Cl₂(CH₃)Si(N(CH₃)₂), Cl₂(CH₃)Si(N(C₂H₅)₂), and Cl(CH₃)₂Si(N(CH₃)₂), Cl(CH₃)₂Si(N(C₂H₅)₂), wherein iso-C₃H₇ is isopropyl, iso-C₄H₉ is isobutyl, and tert-C₄H₉ is tert-butyl.

After the alkoxysilane or amidosilane electron donor compound has been generated in situ by the steps described above, the resulting modified catalyst support material, which contains the in situ-generated alkoxysilane or amidosilane electron donor compound, is then combined with one or more catalytically active transition metal compounds (the transition metal component) to produce a catalyst precursor. The one or more catalytically active transition metal compounds are any metal compounds which possess catalytic activity for the polymerization of an olefin, either alone or in the presence of a main group metal co-catalyst. Preferably, the catalytically active transition metal compounds are selected from the classes of catalytically active titanium and vanadium compounds.

Some examples of suitable titanium compounds include TiBr₃, TiBr₄, TiCl₃, TiCl₄, Ti(OCH₃)Cl₃, Ti(OC₂H₅)Cl₃, Ti(O-iso-C₃H₇)Cl₃, Ti(O-n-C₄H₉)Cl₃, Ti(OC₂H₅)Br₃, Ti(O-n-C₄H₉)Br₃, Ti(OCH₃)₂Cl₂, Ti(OC₂H₅)₂Cl₂, Ti(O-n-C₄H₉)₂Cl₂, Ti(OC₂H₅)₂Br₂, Ti(OCH₃)₃Cl, Ti(OC₂H₅)₃Cl, Ti(O-n-C₄H₉)₃Cl, Ti(OC₂H₅)₃Br, Ti(OCH₃)₄, Ti(OC₂H₅)₄, and Ti(O-n-C₄H₉)₄. Of these, the titanium chlorides, particularly titanium tetrachloride, are preferred.

Some examples of suitable vanadium compounds include the vanadium halogenides (e.g., VCl₃ and VCl₅), the vanadium oxyhalogenides (e.g., vanadium (V) tribromide oxide, vanadium (V) trichloride oxide and vanadium (V) trifluoride oxide), the vanadium alkoxides (e.g., vanadium (V) triisopropoxide oxide), and vanadium (IV) oxyacetylacetonate.

The catalyst precursor described above is then combined with one or more catalytically active main group metal compounds (i.e., main group metal co-catalysts) to form the active catalyst. The one or more catalytically active main group metal compounds are preferably combined with the catalyst precursor during the polymerization reaction (i.e., in the presence of the catalyst precursor and one or more olefin monomers) to produce the active polymerization catalyst. By being “catalytically active,” a main group metal co-catalyst is required to form an active polymerization catalyst when combined with the transition metal-containing catalyst precursor described above.

In a preferred embodiment, the one or more main group co-catalysts are catalytically active aluminum compounds. Particularly preferred aluminum compounds are according to the formula AlR⁷R⁸R⁹. In the formula, R⁷, R⁸, and R⁹ each independently represent H; halo; a saturated or unsaturated, straight-chained or branched, cyclic, polycyclic, or fused hydrocarbon group described above, and more preferably having 1 to 10 carbon atoms; or an alkoxy group of formula —OR^{e} wherein R^{e} represents a saturated or unsaturated, straight-chained or branched, cyclic, polycyclic, or fused hydrocarbon group described above, and more preferably having 1 to 10 carbon atoms. When any of R⁷, R⁸, and R⁹ represents a hydrocarbon group, the hydrocarbon group can be non-derivatized with one or more heteroatoms, or alternatively, derivatized with one or more heteroatoms.

Some examples of suitable aluminum compounds containing at least one aluminum-hydride bond include alane, methylaluminumhydride, dimethylaluminumhydride, ethylaluminumhydride, chloroaluminumhydride, and dichloroaluminumhydride.

Some examples of suitable aluminum compounds containing at least one aluminum-halide bond include aluminum fluoride, aluminum chloride, aluminum bromide, aluminum iodide, methylaluminumdichloride, dimethylaluminumchloride, ethylaluminumchloride, diethylaluminumchloride, n-propylaluminumdichloride, di(n-propyl)aluminumchloride, isopropylaluminumdichloride, diisopropylaluminumchloride, n-butylaluminumdichloride, di(n-butyl)aluminumchloride, isobutylaluminumdichloride, diisobutylaluminumchloride, t-butylaluminumdichloride, di(t-butyl)aluminumchloride, methylethylaluminumchloride, and methylisopropylaluminumchloride.

Some examples of suitable aluminum compounds containing only hydrocarbon groups (i.e., organoaluminum compounds) include trimethylaluminum, triethylaluminum, tri(n-propyl)aluminum, triisopropylaluminum, tri(n-butyl)aluminum, triisobutylaluminum, tri(t-butyl)aluminum, tri(sec-butyl)aluminum, tri(n-pentyl)aluminum, triisopentylaluminum, tri(1-methylpentyl)aluminum, tri(2-methylpentyl)aluminum, tri-(3-methylpentyl)aluminum, tri-(4-methylpentyl)aluminum, tri(n-hexyl)aluminum, tri(1,2-dimethylbutyl)aluminum, tri(1,3-dimethylbutyl)aluminum, tri(1,1-dimethylbutyl)aluminum, tri(2,2-dimethylbutyl)aluminum, tri(3,3-dimethylbutyl)aluminum, tri(2-methylhexyl)aluminum, tri(3-methylhexyl)aluminum, tri(4-methylhexyl)aluminum, tri(5-methylhexyl)aluminum, tri(n-heptyl)aluminum, tri(1-methylhexyl)aluminum, tri(2-methylhexyl)aluminum, tri(3-methylhexyl)aluminum, tri(4-methylhexyl)aluminum, tri(5-methylhexyl)aluminum, tri(1,1-dimethylpentyl)aluminum, tri(2,2-dimethylpentyl)aluminum, tri(3,3-dimethylpentylaluminum, tri(4,4-dimethylpentyl)aluminum, tri(1,2-dimethylpentyl)aluminum, tri(1,3-dimethylpentyl)aluminum, tri(2,3-dimethylpentyl)aluminum, tri(1,4-dimethylpentyl)aluminum, tri(2,4-dimethylpentyl)aluminum, tri(2,2,3,3-tetramethylpropyl)aluminum, tri(n-octyl)aluminum, tri(n-nonyl)aluminum, tri(n-decyl)aluminum, methyldiethylaluminum, dimethylethylaluminum, methyldi(n-propyl)aluminum, dimethyl(n-propyl)aluminum, dimethylisopropylaluminum, diisopropylmethylaluminum, diethyl(n-propyl)aluminum, diethylisopropylaluminum, diisopropylethylaluminum, dimethyl(n-butyl)aluminum, di(n-butyl)methylaluminum, dimethylisobutylaluminum, diisobutylmethylaluminum, di(t-butyl)methylaluminum, t-butyldimethylaluminum, t-butyldiisopropylaluminum, dimethyl(n-pentyl)aluminum, dimethyl(n-octyl)aluminum, diisopropyl(n-octyl)aluminum, tricyclopentylaluminum, tricyclohexylaluminum, triphenylaluminum, methyldiphenylaluminum, and dimethylphenylaluminum.

Some examples of suitable aluminum compounds containing at least one aluminum-alkoxide bond include aluminum methoxide (Al(OCH₃)₃), aluminum ethoxide, aluminum n-propoxide, aluminum isopropoxide, aluminum n-butoxide, aluminum isobutoxide, aluminum t-butoxide, aluminum n-pentoxide, dimethylaluminummethoxide, dimethylaluminumisopropoxide, methylaluminumdimethoxide, methylaluminumdiisopropoxide, dimethoxyaluminumchloride, and diisopropoxyaluminumchloride.

The transition metal catalyst component can include one or a suitable combination of catalytically active transition metal compounds, and preferably, any one or combination of the compounds described above. Similarly, the main group metal co-catalyst can include one or a suitable combination of catalytically active main group metal compounds, and preferably, any one or combination of the compounds described above.

The catalytically active transition metal and main group metal co-catalyst compounds can be in any suitable physical form or in any suitable purity level. In addition, the catalytically active transition metal and co-catalyst compounds can be combined with any suitable atoms or chemical compounds which may, for example, enhance or benefit the polymerization process or production of the catalyst.

The starting catalyst support materials containing a magnesium component, described earlier, can be synthesized by any suitable means. For example, in one embodiment, a catalyst support material containing a magnesium(Y) component is synthesized by reacting an organomagnesium metal oxide support material with an alcohol compound or an amine compound.

The organomagnesium metal oxide support material includes an organomagnesium component and a metal oxide support component. Preferably, the organomagnesium component is a coating on the metal oxide support. The organomagnesium component is either bound or complexed to the metal oxide component.

The organomagnesium component is any compound or material containing magnesium atoms bound to one or more hydrocarbon groups. The hydrocarbon group bound to the magnesium is preferably any of the hydrocarbon groups described above. For example, the organomagnesium component can be according to the formula magnesium(R^{b})ᵥ wherein R^{b} represents any of the saturated or unsaturated, straight-chained or branched, cyclic, polycyclic, or fused hydrocarbon groups described above. More preferably, R^{b} represents any of the hydrocarbon groups described above having 1 to 10 carbon atoms. The subscript v is preferably 1 or 2 depending on whether the organomagnesium compound or material is bound (where v is preferably 1) or is complexed (where v is preferably 2) to the metal oxide component.

In a preferred method for producing a Mg(Y)-metal oxide support, an alcohol or amine compound (YH) is deprotonated by a hydrocarbon group on the organomagnesium component to form a volatile hydrocarbon and the Mg(Y) component. The following equation demonstrates this principle (wherein R is any of the hydrocarbon groups described above):
RMg-MO+YH→Y—Mg-MO+RH

The alcohol used to react with the organomagnesium component can be any of the alcohols described above according to formula R^{a}—OH. Some examples of suitable alcohols include methanol, ethanol, 1-propanol, isopropanol, 1-butanol, iso-butanol, tert-butanol, sec-butanol, 1-pentanol, iso-pentanol, neo-pentanol, 2-pentanol, 3-pentanol, 1-hexanol, 2-hexanol, 3-hexanol, 1-heptanol, 2-heptanol, 3-heptanol, 4-heptanol, 2-ethylhexanol, 1-octanol, 2-octanol, 3-octanol, 4-octanol, phenol, 2-methylphenol, 2,6-dimethylphenol, 3,5-dimethylphenol, and 2,4,6-trimethylphenol. A particularly preferred alcohol is ethanol.

The amine used to react with the organomagnesium component can be any suitable amine. Preferably, the amine is of the formula R^{c}R^{d}NH, wherein R^{c} and R^{d} each independently represents H or any of the saturated or unsaturated, straight-chained or branched, cyclic, polycyclic, or fused hydrocarbon groups described above, and preferably having 1 to 10 carbon atoms. Optionally, R^{c} and R^{d} can connect to form a nitrogen ring group. The amine compound has at least one nitrogen atom, and can have any suitable number of additional nitrogen atoms or other heteroatoms.

Some preferred amine compounds according to the formula R^{c}R^{d}NH above include ammonia, methylamine, ethylamine, hydroxylamine, n-propylamine, isopropylamine, n-butylamine, isobutylamine, sec-butylamine, t-butylamine, dimethylamine, diethylamine, methylethylamine, n-propylmethylamine, di(n-propyl)amine, diisopropylamine, di(n-butyl)amine, diisobutylamine, di(sec-butyl)amine, di(t-butyl)amine, isopropylmethylamine, n-butylmethylamine, isobutylmethylamine, t-butylmethylamine, isobutylethylamine, t-butylethylamine, vinylamine, vinylmethylamine, benzylamine, benzylmethylamine, 1,2-ethylenediamine, 1,3-propylenediamine, piperidine, piperazine, imidazole, pyrrole, and pyrrolidine.

In accordance with the invention, the molar equivalents of the alcohol or amine with respect to the organomagnesium component is preferably adjusted to quantitatively convert the organomagnesium component to the magnesium(Y) component. Preferably, there is no significant excess of the alcohol or amine beyond that required for the quantitative conversion of organomagnesium component to the magnesium(Y) component. The optimal molar equivalents of the alcohol can be conveniently calculated according to the following formula:

$${Eq}_{( YH )} = 2 \times \frac{[ ( mmole MgR \text{/} g support ) - 2.1 - 0.55 \times wt \% ( {H}_{2} O ) \text{/} support ]}{[ mmole MgR \text{/} g support ]}$$

In the above formula, Eq_{(YH)} stands for the molar equivalents of alcohol or amine compound relative to the molar amount of magnesium; “mmole MgR/g support” stands for the mmoles of magnesium in the organomagnesium component per gram of solid support; and “wt % (H₂O)/support” stands for the weight percent of physically adsorbed water on the solid support.

Preferably, the molar equivalent of alcohol or amine used is at least about as much as, while not exceeding by more than about fifteen percent, the value of Eq_{(YH)} as determined by the formula above. More preferably, the molar equivalent of alcohol or amine does not exceed Eq_{(YH)} by more than about 10%, more preferably about 8%, more preferably about 6%, more preferably about 4%, and even more preferably about 2%.

A catalyst support material containing an alcohol-adducted magnesium halide component can be synthesized by any appropriate means. For example, in a preferred embodiment, the alcohol-adducted magnesium halide component is synthesized by complexing a magnesium halide metal oxide support material with an alcohol compound of formula R^{a}—OH (wherein R^{a} is as described above) by any suitable means known in the art. The alcohols described and exemplified above according to the formula R^{a}—OH apply herein as well.

In a preferred embodiment, the catalyst support material is produced by contacting an organomagnesium-metal oxide catalyst support or a magnesium halide-metal oxide support with an alcohol or amine compound under suitable conditions. Suitable conditions include, inter alia, a suitable amount of time, temperature, and pressure during which contact occurs.

For example, a Mg(Y)-metal oxide catalyst support is preferably produced by contacting an organomagnesium-metal oxide catalyst support with an alcohol or amine compound under reactions suitable for the reaction of the organomagnesium component with the alcohol or amine. Alternatively, an alcohol-adducted magnesium halide-metal oxide catalyst support is preferably produced by contacting a magnesium halide-metal oxide support with an alcohol under conditions suitable for the adduction (i.e., complexation) of the alcohol with the magnesium halide component.

The organomagnesium or magnesium-halide metal oxide supports can be contacted with the alcohol and/or amine compound by any suitable means. For example, the support material can be contacted with the alcohol or amine compound in the vapor phase. More preferably, the organomagnesium or magnesium-halide metal oxide support materials are contacted with the alcohol or amine compound in a suitable liquid medium.

The magnesium halide metal oxide support material includes a magnesium halide component bound or complexed to a metal oxide component. The magnesium halide component includes, minimally, discrete molecules or a repeating chemical structure incorporating a magnesium halide (Mg—X) bond wherein X is a halide. The halide (X) can be, for example, flouride, chloride, bromide, iodide, or a combination thereof. Preferably, the halide is chloride. More preferably, the magnesium halide component is according to the formula MgX₂, and even more preferably, MgCl₂. The magnesium halide units can be non-complexed to other molecules, or alternatively, complexed to one or more molecules. For example, the magnesium halide units may be complexed to solvent molecules, e.g., MgCl₂.xEtOH or MgCl₂.xH₂O wherein EtOH is ethanol and x is any suitable value.

The magnesium halide metal oxide support material can be produced by any suitable method. In a preferred embodiment, the magnesium halide metal oxide support material is produced by reacting an organomagnesium-coated metal oxide support material, as described above, with a suitable halogenating agent. A suitable halogenating agent must be capable of converting the organomagnesium component to a magnesium halide component. Some examples of suitable halogenating agents include hydrogen halides, dihalogens, silane chlorides (e.g., tetrachlorosilane), and carbon chlorides (such as carbon tetrachloride).

Preferably, the halogenating agent is a hydrogen halide according to the formula HX or a dihalogen molecule according to the formula X₂ wherein H is a hydrogen atom and X is a halogen atom. Preferably, the halogen atom is a chlorine atom. Some examples of particularly preferred halogenating agents include hydrogen chloride (HCl) and chlorine (Cl₂).

The starting organomagnesium metal oxide support material can be produced by any suitable method. Preferably, the organomagnesium metal oxide support is generated by combining a metal oxide support material with one or more organomagnesium compounds. The organomagnesium compounds are required, under suitable conditions, to bond or complex with the metal oxide support material. Once bound or complexed, the organomagnesium compound preferably retains at least some portion of the hydrocarbon groups attached to the magnesium.

The one or more organomagnesium compounds preferably dissolve in an amount of at least 5% by weight at ambient temperature in an aliphatic or aromatic hydrocarbon solvent essentially devoid of oxygenated co-solvents such as ethers. One or more solubilizing aides may be combined with the organomagnesium compound to increase its solubility in the hydrocarbon solvent. For example, a suitable organometallic compound, such as a tris(alkyl)aluminum compound, may be added in order to increase the solubility of the organomagnesium compound.

Preferably, the organomagnesium compound is according to the formula Mg(R^{b})₂, wherein R^{b} is as described above. Preferably, R^{b} is selected from any of the hydrocarbon groups described above and having 1 to 10 carbon atoms. Some examples of suitable organomagnesium compounds include dimethylmagnesium, diethylmagnesium, ethylmethylmagnesium, di-(n-propyl)magnesium, diisopropylmagnesium, n-propylmethylmagnesium, isopropylmethylmagnesium, di-(n-butyl)magnesium, di-(sec-butyl)magnesium, diisobutylmagnesium, di-(tert-butyl)magnesium, di(n-pentyl)magnesium, diisopentylmagnesium, di(n-hexyl)magnesium, di(n-heptyl)magnesium, di(n-octyl)magnesium, n-butylmethylmagnesium, n-butylethylmagnesium, n-butyl(sec-butyl)magnesium, methyloctylmagnesium, n-butyloctylmagnesium, methyl(benzyl)magnesium, ethyl(benzyl)magnesium, dibenzylmagnesium, methyl(phenyl)magnesium, ethyl(phenyl)magnesium, diphenylmagnesium, bis(2-methylphenyl)magnesium, bis(2,6-dimethylphenyl)magnesium, bis(2,4,6-trimethylphenylmagnesium), (2,6-dimethylphenyl)methylmagnesium, dicyclohexylmagnesium, cyclohexylmethylmagnesium, cyclohexylethylmagnesium, cyclohexylisopropylmagnesium, bis(cyclopentadienyl)magnesium, methylcyclopentadienylmagnesium, ethylcyclopentadienylmagnesium, isopropylcyclopentadienylmagnesium, bis(ethylcyclopentadienyl)magnesium, and bis(pentamethylcyclopentadienyl)magnesium.

In a preferred embodiment, at least some portion of the method for producing the polymerization catalyst is conducted in a liquid medium. Any liquid medium which does not interfere with production of the catalyst or with the intended function of the catalyst for polymerizing olefins can be used according to the present invention. A preferred liquid medium in which to contact the magnesium support material with the alcohol or amine compound, but by no means the only suitable liquid medium, is a hydrocarbon solvent. The hydrocarbon solvent is any solvent other than water or water-soluble solvents. Some examples of suitable hydrocarbon solvents include the hexanes, heptanes, octanes, toluenes, benzene, xylenes, ethylbenzene, diethylbenzenes, and ethers.

In a preferred embodiment, a catalyst precursor is produced according to the following method. An organomagnesium metal oxide support is first produced by using a two-stage process, as follows. First, a particulate porous support of an inorganic metal oxide is suspended in an inert solvent. Preferably, the inert solvent is a liquid alkane (e.g., hexane, heptane, octane, etc.) or aromatic hydrocarbon solvent (e.g., toluene or ethylbenzene). The resulting slurry is then treated with a solution of a hydrocarbon-soluble organomagnesium compound in an amount which is approximately in a 2:1 molar ration of metal oxide to magnesium. The mixture is then preferably heated to a temperature of from about 10° C. to about 120° C. for about thirty minutes to about five hours, typically while stirring. Next, a stoichiometric amount of a C₁-C₈ alcohol compound is added at a temperature between about −20° C. and 50° C., more preferably between 0° C. and 10° C., and then heated up to approximately 40° C. to 80° C., or to the boiling point of the solvent, for a period of approximately 20 to 90 minutes.

The contents are then cooled and one or more silane halide compounds are added to the mixture. The silane halide compound can be used in a stoichiometric, higher than stoichiometric, or lower than stoichiometric amount as compared to the amount of ethanol added. The mixture is again heated, preferably to about 40° C. to 80° C., or to the boiling point of the solvent, and held at this temperature for about fifteen to forty-five minutes. The solution is then preferably cooled to approximately −20° C. to 40° C., and more preferably between 0° C. and 20° C.

Next, a compound of titanium or vanadium is added in an amount of preferably from about 1 to about 15 times, more preferably from about 2 to about 10 times, the moles of magnesium. The resulting mixture is allowed to react, preferably while stirring, for approximately thirty minutes to one hour at a temperature in the range of from about 10° C. to 150° C., and more preferably from about 60° C. to about 120° C. The resulting solid product is then collected by filtration and washed with a hydrocarbon solvent.

In the second stage, the solid product resulting from the first stage is extracted with an excess of, e.g., titanium tetrachloride, preferably as a solution of titanium tetrachloride in an inert solvent, preferably a C₇-C₁₀ alkylbenzene, containing at least 5% by weight of titanium tetrachloride. Typically, the extraction is continued for about thirty minutes to three hours, more preferably about two hours, at about 90° C. to about 150° C. The product is washed with a hydrocarbon solvent until the content of titanium tetrachloride in the filtrate is less than approximately 2% by weight.

The solid catalytic component preferably has a molar ratio of the inorganic oxide to the compound of titanium or vanadium in the range of from 1000 to 1, more preferably from 100 to 2, and in particular from 50 to 3.

Preferably, the aluminum co-catalyst is added to the titanium-containing catalyst precursor, described above, during the polymerization reaction in such an amount that the atomic ratio of the aluminum compound to the catalytically active transition metal (i.e., titanium) is from about 10:1 to about 800:1, and more preferably from about 20:1 to about 200:1.

In addition to the aluminum compound, the catalytic system of the invention can optionally include an external electron donor compound. Some examples of suitable external electron donor compounds include mono- and poly-functional carboxylic acids, carboxylic anhydrides, carboxylic esters, ketones, ethers, alcohols, lactones, organophosphorus, and alkoxysilicon compounds. A mixture of two or more external electron donor compounds may also be used. Particularly preferred external electron donor compounds are selected from the class of alkoxysilicon compounds, and even more preferably, from the alkoxysilicon compounds according to formula (5), as described above.

Some particularly preferred external electron donor compounds include diisopropyldimethoxysilane, isobutylisopropyldimethoxysilane, diisobutyldimethoxysilane, dicyclopentyldimethoxysilane, cyclohexylmethyldimethoxysilane, dicyclohexyldimethoxysilane, isopropyl-(tertbutyl)dimethoxysilane, isopropyl-(sec-butyl)dimethoxysilane, and isobutyl-(sec-butyl)dimethoxysilane.

The aluminum co-catalyst and one or more external electron donor compounds can be contacted with the transition metal-containing catalyst precursor in any suitable order, or as a combined mixture, normally at a temperature in the range of from about 0° C. to about 200° C., preferably from about 20° C. to about 90° C. and at a pressure of from about 1 to about 100 bar, and more preferably from about 1 to about 40 bar.

In another aspect, the invention is directed to a method for polymerizing one or more olefins by contacting one or more olefin monomers with the polymerization catalyst of the invention under conditions suitable for the polymerization of the olefin monomers. The polymerization catalyst of the invention is particularly suited for the polymerization of 1-alkene olefins. Some particularly suitable 1-alkenes are those having a maximum of about ten carbon atoms. Some examples of such 1-alkene olefins include ethene, vinyl chloride (CH₂═CHCl), vinyl fluoride (CH₂═CHF), vinylidene chloride (CH₂═CCl₂), vinylidene fluoride (CH₂═CF₂), tetrafluoroethene (CF₂═CF₂), propene, 2-methylpropene, 2-chloropropene, 3-chloropropene, 1-chloro-2-methylpropene, 3-chloro-2-methylpropene, 1,3-dichloropropene, 1-butene, 2-methyl-1-butene, 3-methyl-1-butene, 2,3-dimethyl-1-butene, 3,3-dimethyl-1-butene, 1-pentene, 1-hexene, 1-heptene, 1-octene, 1-nonene, 1-decene, 4-methyl-1-pentene, 4,4-dimethyl-1-pentene, 4-methyl-1-hexene, 5-methyl-1-hexene, 4,4-dimethyl-1-hexene, 4-methyl-1-heptene, 5-methyl-1-heptene, 6-methyl-1-heptene, 1,3-butadiene, 2-methyl-1,3-butadiene, 2,3-dimethyl-1,3-butadiene, chloroprene (2-chloro-1,3-butadiene), 2,3-dichloro-1,3-butadiene, isoprene, chloroprene, 1,2-divinylbenze, 1,3-divinylbenzene, 1,4-divinylbenzene, and styrene.

In addition to the 1-alkenes exemplified above, a variety of functionalized 1-alkenes can also be suitable substrates for polymerization according to the present invention. Some examples of suitable functionalized 1-alkene monomers include acrylonitrile (CH₂═CHCN), acrylamide (CH₂═CHC(O)NH₂), acrylic acid, methylacrylate (CH₂═CH—COOCH₃), ethylacrylate, n-propyl acrylate, iso-propyl acrylate, n-butyl acrylate, iso-butyl acrylate, sec-butyl acrylate, tert-butyl acrylate, methacrylic acid (CH₂═C(CH₃)—COOH), methyl methacrylate (CH₂═C(CH₃)—COOCH₃), ethyl methacrylate, propyl methacrylate, n-butyl methacrylate, iso-butyl methacrylate, sec-butyl methacrylate, tert-butyl methacrylate, fumaric acid, maleic acid, 3-methacrylic acid, 3,3-dimethylacrylic acid, 2,3-dimethylacrylic acid, 2-fluoroacrylic acid, 3-chloroacrylic acid, 2-cyanoacrylic acid, hydroxylethylacrylate, hydroxylethylmethacrylate, aminoethylacrylate, aminoethylmethacrylate, N,N-dimethylaminoethylmethacrylate, t-butylaminoethylacrylate, vinyl acetate, and 3-butenoic acid.

The polymer can be derived from a single type of olefin monomer, thus forming a homopolymer. Some examples of suitable homopolymers include polyethylene, linear unbranched polyethylene, polypropylene (isotacetic and syndiotactic), and polyvinylchloride.

The polymer can also be derived from two or more different types of olefin monomers, thus forming a copolymer. The copolymer can include, for example, terpolymers and tetrapolymers. Preferably, at least one of the monomers used for producing a copolymer is a 1-alkene monomer.

The copolymers can have any distribution of the monomer units. For example, the copolymer can be a random copolymer, an alternating copolymer, a block copolymer, a graft copolymer, or a combination thereof.

The polymerization catalyst of the invention is particularly suited for use in the production of propylene (i.e., propene) polymers. The propylene polymers include both homopolymers of propylene as well as copolymers of propylene. The copolymers of propylene include propylene and any number of other alkenes other than propylene. Preferably, the one or more 1-alkenes other than propylene have up to 10 carbon atoms.

The polymerization reaction can be carried out in any common reactor suitable for the polymerization of olefins. Additionally, the reaction can be conducted in a batchwise or continuous mode. The reaction can also be conducted in solution (i.e., as bulk phase), as suspension polymerization or as gas phase polymerization. Examples of suitable reactors include continuously operated stirred reactors, loop reactors, fluid bed reactors, or horizontal or vertical stirred powder bed reactors. The polymerization may also be carried out in a series of consecutively coupled reactors. The reaction time depends on the chosen reaction conditions. Typically, the reaction time is from about 0.2 to about 20 hours, and more typically from about 0.5 to about 10 hours.

The polymerization is conducted at a temperature preferably in the range of from about 20° C. to about 150° C., more preferably from about 50° C. to about 120° C., and even more preferably from about 60° C. to about 90° C. The polymerization is conducted at a pressure preferably in the range of from about 1 to 100 bar, more preferably from about 15 to about 40 bar, and even more preferably from about 20 to about 35 bar.

The molecular weight of the resulting polymers may be controlled and adjusted over a wide range by adding polymer chain transfer or termination inducing agents as commonly used in the art of polymerization, such as hydrogen. In addition, an inert solvent, such as toluene or hexane, or an inert gas, such as nitrogen or argon, and smaller amounts of a powdered polymer, e.g., polypropylene powder, may be added during the polymerization process or added to the final polymer.

The average molecular weights of the polymers produced by using the method of the invention can be typically in the range of from about 10,000 to 1,000,000 g/mole with melt flow rates in the range of from about 0.1 to 100 g/10 min or about 0.5 to 50 g/10 min. By at least one method, the melt flow rate corresponds to the amount of polymer which is pressed within 10 minutes from a test instrument in accordance with ISO 1133 at a temperature of 230° C. and under a load of 2.16 kg.

In addition, the resulting polymers, as obtained according to the method of the invention can be further processed. For example, the polymers may be pressed, molded, extruded, or pelletized to produce various end products, including films, fibers, moldings, powders, containers, or beads.

Examples have been set forth below for the purpose of illustration. The scope of the invention is not to be in any way limited by the examples set forth herein.

### EXAMPLE 1

### Synthesis of a Catalyst Precursor Via a Mg(Y)-Metal Oxide Catalyst Support

Ten grams of Grace Davison's Syllopol 2229 are charged to a 1000 ml, four-neck flask and then suspended in 150 ml of ethylbenzene. While stirring the mixture with a glass rod equipped with a Teflon paddle, 76 ml of 15 wt. % butylethylmagnesium are slowly added at room temperature (SiO₂/Mg molar ratio=2/1). The contents are heated to 95° C., held there for 30 minutes, and then cooled to 5° C. Then 6.1 ml of EtOH diluted with an equal amount of ethylbenzene are slowly added to the flask. The mixture is then heated to 60° C. and held there for 30 minutes.

The contents are then cooled to room temperature and 11.2 ml (13.7 grams) of diphenyldichlorosilane are added. The mixture is again heated to 60° C., held there for 30 minutes and then cooled to +10° C. 53.8 ml of titanium tetrachloride (35.8 grams) are slowly added. The mixture is finally heated and held at 105° C. for 1 hour.

The catalyst is subsequently extracted for 2 hours at 120° C. using a 10 vol % mixture of titanium tetrachloride and ethylbenzene. After extraction, the solid is collected, washed thoroughly to remove excess titanium tetrachloride, and then vacuum dried.

### EXAMPLE 2

### Synthesis of a Catalyst Precursor Via a Alcohol-Adducted Magnesium Halide-Metal Oxide Catalyst Support

Ten grams of Grace Davison's Syllopol 2229 are charged to a 1000 ml four-neck flask and then suspended in 150 ml of ethylbenzene. While stirring the mixture with a glass rod equipped with a Teflon paddle, 76 ml of 15 wt. % butylethylmagnesium are slowly added at room temperature (SiO₂/Mg molar ratio=2/1). The contents are heated to 95° C., held there for 30 minutes, and then cooled to room temperature. Gaseous HCl is then introduced into the mixture using a Teflon tube. HCl is slowly bubbled into the slurry until all the magnesium has been chlorinated. Completion of the chlorination can be determined by monitoring the flow rate differences between inlet and outlet bubblers. As the chlorination reaches completion, the flow rates will approach one another. Once the chlorination is complete, the excess HCl is removed by sparging the bright yellow suspension with nitrogen.

Subsequently, 12 ml of ethanol (0.2125 moles) are added and the slurry heated to 80° C. for 15 minutes. The mixture is then cooled to +10° C., before adding 25.6 ml of dicyclohexyldichlorosilane. The mixture is heated to 60° C., then held there for 30 minutes, and then cooled to +10° C. Then 53.8 ml of titanium tetrachloride (35.8 grams) are slowly added. The mixture is then heated and held at 105° C. for 1 hour.

The catalyst is subsequently extracted for two hours at 120° C. using a 10 vol % mixture of titanium tetrachloride and ethylbenzene. After extraction, the solid is collected, washed thoroughly to remove excess titanium tetrachloride, and then vacuum dried.

### EXAMPLE 3

### Bulk Polymerization Procedure

0.5 grams of hydrogen are added to a 5-liter reactor using a mass flow meter. Five milliliters of 1.6M triethylaluminum and two milliliters of 0.1M “C-donor” (cyclohexylmethyldimethoxysilane) are then flushed into the reactor using 900 g of liquid propylene at ambient temperature. After stirring for 2 minutes, the catalyst (25 mg slurried in 10 ml of heptane) is flushed into the reactor with another of 900 g of liquid propylene. The reactor is heated to 70° C. in 10 minutes and held at 70° C. for 1 hour. After 60 minutes of polymerization, the reaction is terminated by venting the unreacted propylene and cooling to the reactor to room temperature. The polypropylene homopolymer is recovered and the catalytic productivity (g polymer/g solid catalytic component in 1 hour) is determined gravimetrically. The melt flow rate and the isotacticity index of the polymer, based on the xylene solubles, are determined on the dry reactor powder.

### EXAMPLE 4

### Gas Phase Polymerization Procedure

0.08 grams of hydrogen are added to a 5-liter reactor using a mass flow meter. 1.5 milliliters of 1.6M triethylaluminum and 1.2 milliliters of 0.0.025M “C-donor” (cyclohexylmethyldimethoxysilane) are then flushed into the reactor using 160 g of liquid propylene at ambient temperature. The reactor is heated to 40° C.; at which point the catalyst (25 mg slurried in 10 ml of heptane) is flushed into the reactor with another 260 g of liquid propylene. The reactor is then heated to 75° C. in 10 min and held at 75° C. and 400 psig for 1 hour by feeding gaseous propylene on demand. After 60 minutes, the polymerization reaction is terminated by venting the unreacted propylene and cooling to room temperature. The polypropylene homopolymer is recovered and the catalytic productivity (g polymer/g solid catalytic component in 1 hour) determined gravimetrically. The melt flow rate and the isotacticity index of the polymer, based on the xylene solubles, are determined on the dry reactor powder.

Thus, whereas there have been described what are presently believed to be the preferred embodiments of the present invention, those skilled in the art will realize that other and further embodiments can be made without departing from the spirit of the invention, and it is intended to include all such further modifications and changes as come within the true scope of the claims set forth herein.

We claim:

1. A method for producing a polymerization catalyst, the method comprising:
(a) providing a catalyst support material comprising a magnesium component bound or complexed to a metal oxide component, said magnesium component being either a magnesium(Y) component wherein Y is an alkoxide group or amido group, or an alcohol-adducted magnesium halide component, provided that when the magnesium component is the magnesium(Y) component then any magnesium halide component is excluded from the catalyst support material, and when the magnesium component is the alcohol-adducted magnesium halide component then a magnesium(Y) component and any organomagnesium component are excluded from the catalyst support material;
(b) reacting the magnesium component with one or more silane halide compounds to provide a modified catalyst support material by either:
(i) reacting the magnesium(Y) component with one or more silane halide compounds capable of converting the magnesium(Y) component to a magnesium halide component and capable of being converted to either one or more alkoxysilane electron donor compounds when Y is an alkoxide group or to one or more amidosilane electron donor compounds when Y is an amido group, or
(ii) reacting the alcohol-adducted magnesium halide component with one or more silane halide compounds capable of reacting with the adducted alcohol to form one or more alkoxysilane electron donor compounds,
wherein said modified catalyst support material comprises said one or more alkoxysilane electron donor compounds or said one or more amidosilane electron donor compounds and a magnesium halide component bound or complexed to the metal oxide component;
(c) combining said modified catalyst support material of step (b) with one or more catalytically active transition metal compounds to provide a catalyst precursor; and
(d) combining said catalyst precursor with one or more catalytically active main group metal compounds, thereby producing said polymerization catalyst.

2. A method according to claim 1, wherein the silane halide compound is according to the formula:
R¹ₘR²ₙR³ᵣSiX₄₋ₘ₋ₙ₋ᵣ (1)
wherein R¹, R², and R³ each independently represent H, or a saturated or unsaturated, straight-chained or branched, or cyclic, polycyclic, or fused hydrocarbon group having 1 to 50 carbon atoms, wherein one or more hydrocarbon groups are either non-derivatized with heteroatoms, or optionally, independently derivatized with one or more heteroatoms selected from oxygen, nitrogen, or halogen atoms, and wherein optionally, when two or three of R¹, R², and R³ are said hydrocarbon groups, two or three of said hydrocarbon groups are connected to form a silicon-containing ring or polycyclic ring system;
X represents a halogen atom; and
m, n, and r independently represent 0 or 1.

3. A method according to claim 2, wherein X represents a chlorine atom.

4. A method according to claim 3, wherein R¹, R², and R³ independently represent saturated or unsaturated, straight-chained or branched, or cyclic, polycyclic, or fused hydrocarbon groups having 1 to 10 carbon atoms, said hydrocarbon groups being non-derivatized with heteroatoms.

5. A method according to claim 4, wherein the silane halide compound is according to the formula:
R¹SiCl₃ (2)
wherein R¹ is as defined in claim 4.

6. A method according to claim 4, wherein the silane halide compound is according to the formula:
R¹R²SiCl₂ (3)
wherein R¹ and R² are as defined in claim 4.

7. A method according to claim 4, wherein the silane halide compound is according to the formula:
R¹R²R³SiCl (4)
wherein R¹, R², and R³ are as defined in claim 4.

8. A method according to claim 1, wherein the one or more silane halide compounds are selected from the group consisting of diphenyldichlorosilane, dicyclohexyldichlorosilane, and tetrachlorosilane.

9. A method according to claim 1, wherein the catalyst support material comprises a magnesium(Y) component bound or complexed to a metal oxide component.

10. A method according to claim 9, wherein the magnesium(Y) component is a magnesium(alkoxide) component according to the formula —Mg(OR^{a}) wherein R^{a} represents a saturated or unsaturated, straight-chained or branched, cyclic, polycyclic, or fused hydrocarbon group having 1 to 10 carbon atoms, said magnesium(alkoxide) component reacting with one or more silane halide compounds to provide one or more alkoxysilane electron donor compounds.

11. A method according to claim 10, wherein said one or more alkoxysilane electron donor compounds are according to the formula:
R⁴ₛR⁵ₜR⁶ᵤSi(OR^{a})₄₋ₛ₋ₜ₋ᵤ (5)
wherein R⁴, R⁵, and R⁶ each independently represent H, halide, or a saturated or unsaturated, straight-chained or branched, or cyclic, polycyclic, or fused hydrocarbon group having 1 to 50 carbon atoms, wherein one or more hydrocarbon groups are either non-derivatized with heteroatoms, or optionally, independently derivatized with one or more heteroatoms selected from oxygen, nitrogen, or halogen atoms, and wherein optionally, when two or three of R⁴, R⁵, and R⁶ are said hydrocarbon groups, two or three of said hydrocarbon groups are connected to form a silicon-containing ring or polycyclic ring system;
R^{a} represents a saturated or unsaturated, straight-chained or branched, cyclic, polycyclic, or fused hydrocarbon group having 1 to 10 carbon atoms; and
s, t, and u independently represent 0 or 1.

12. A method according to claim 11, wherein the alkoxysilane electron donor compound is according to the formula:
R^{a}OSiCl₃ (6)
wherein R^{a} represents a saturated or unsaturated, straight-chained or branched, cyclic, polycyclic, or fused hydrocarbon group having 1 to 10 carbon atoms.

13. A method according to claim 11, wherein the alkoxysilane electron donor compound is according to the formula:
(R^{a}O)₂SiCl₂ (7)
wherein R^{a} represents a saturated or unsaturated, straight-chained or branched, cyclic, polycyclic, or fused hydrocarbon group having 1 to 10 carbon atoms.

14. A method according to claim 11, wherein the alkoxysilane electron donor compound is according to the formula:
R⁴R⁵Si(OR^{a})₂ (8)
wherein R^{a}, R⁴ and R⁵ each independently represent a saturated or unsaturated, straight-chained or branched, or cyclic, polycyclic, or fused hydrocarbon group having 1 to 10 carbon atoms.

15. A method according to claim 1, wherein the catalyst support material comprises an alcohol-adducted magnesium halide component bound or complexed to a metal oxide component.

16. A method according to claim 15, wherein the alcohol-adducted magnesium halide component is according to the formula MgX₂.xR^{a}OH wherein X represents a halogen atom, R^{a} represents a saturated or unsaturated, straight-chained or branched, cyclic, polycyclic, or fused hydrocarbon group having 1 to 10 carbon atoms, and x has a suitable value greater than zero.

17. A method according to claim 16, wherein the halide is chloride and x has a minimum value of about 1 and a maximum value of about 3.

18. A method according to claim 15, wherein said alcohol-adducted magnesium halide component reacts with one or more silane halide compounds capable of reacting with the adducted alcohol to form one or more alkoxysilane electron donor compounds by an acid elimination reaction, said one or more alkoxysilane electron donor compounds according to the formula:
R⁴ₛR⁵ₜR⁶ᵤSi(OR^{a})₄₋ₛ₋ₜ₋ᵤ (5)
wherein R⁴, R⁵, and R⁶ each independently represent H, halide, or a saturated or unsaturated, straight-chained or branched, or cyclic, polycyclic, or fused hydrocarbon group having 1 to 50 carbon atoms, wherein one or more hydrocarbon groups are either non-derivatized with heteroatoms, or optionally, independently derivatized with one or more heteroatoms selected from oxygen, nitrogen, or halogen atoms, and wherein optionally, when two or three of R⁴, R⁵, and R⁶ are said hydrocarbon groups, two or three of said hydrocarbon groups are connected to form a silicon-containing ring or polycyclic ring system;
R^{a} represents a saturated or unsaturated, straight-chained or branched, cyclic, polycyclic, or fused hydrocarbon group having 1 to 10 carbon atoms; and
s, t, and u independently represent 0 or 1.

19. A method according to claim 18, wherein the alkoxysilane electron donor compound is according to the formula:
R^{a}OSiCl₃ (6)
wherein R^{a} represents a saturated or unsaturated, straight-chained or branched, cyclic, polycyclic, or fused hydrocarbon group having 1 to 10 carbon atoms.

20. A method according to claim 18, wherein the alkoxysilane electron donor compound is according to the formula:
(R^{a}O)₂SiCl₂ (7)
wherein R^{a} represents a saturated or unsaturated, straight-chained or branched, cyclic, polycyclic, or fused hydrocarbon group having 1 to 10 carbon atoms.

21. A method according to claim 18, wherein the alkoxysilane electron donor compound is according to the formula:
R⁴R⁵Si(OR^{a})₂ (8)
wherein R^{a}, R⁴ and R⁵ each independently represent a saturated or unsaturated, straight-chained or branched, or cyclic, polycyclic, or fused hydrocarbon group having 1 to 10 carbon atoms.

22. A method according to claim 1, wherein said metal oxide support material comprises a silicon oxide material.

23. A method according to claim 9 further comprising generating said catalyst support material by a method comprising reacting an organomagnesium-coated metal oxide support material, said organomagnesium-coated metal oxide support material comprising an organomagnesium component of formula magnesium(R^{b})ᵥ bound or complexed to a metal oxide component, with an alcohol compound of formula R^{a}—OH or an amine compound of formula R^{c}R^{d}NH, wherein R^{a} and R^{b} each independently represents a saturated or unsaturated, straight-chained or branched, cyclic, polycyclic, or fused hydrocarbon group having 1 to 10 carbon atoms; R^{c} and R^{d} each independently represents H or a saturated or unsaturated, straight-chained or branched, cyclic, polycyclic, or fused hydrocarbon group having 1 to 10 carbon atoms, and wherein optionally, R^{c} and R^{d} connect to form a nitrogen ring group; and v is 1 or 2.

24. A method according to claim 23 further comprising generating said organomagnesium-coated metal oxide support material by combining a metal oxide support material with one or more organomagnesium compounds under conditions suitable for the bonding or complexing of the one or more organomagnesium compounds with the metal oxide support material.

25. A method according to claim 24, wherein said organomagnesium compound is according to the formula Mg(R^{b})₂, wherein each R^{b} independently represents a saturated or unsaturated, straight-chained or branched, cyclic, polycyclic, or fused hydrocarbon group having 1 to 10 carbon atoms.

26. A method according to claim 15 further comprising generating said catalyst support material by a method comprising complexing a magnesium halide metal oxide support material with an alcohol compound of formula R^{a}—OH wherein R^{a} represents a saturated or unsaturated, straight-chained or branched, cyclic, polycyclic, or fused hydrocarbon group having 1 to 10 carbon atoms, wherein said magnesium halide metal oxide support material comprises a magnesium halide component bound or complexed to a metal oxide component.

27. A method according to claim 26 further comprising generating said magnesium halide metal oxide support material by reacting an organomagnesium-coated metal oxide support material, said organomagnesium-coated metal oxide support material comprising an organomagnesium component of formula magnesium(R^{b})ᵥ bound or complexed to a metal oxide component, with a suitable halogenating agent capable of converting said organomagnesium component to a magnesium halide component, wherein R^{b} independently represents a saturated or unsaturated, straight-chained or branched, cyclic, polycyclic, or fused hydrocarbon group having 1 to 10 carbon atoms and v is 1 or 2.

28. A method according to claim 27, wherein the halogenating agent has the formula HX or X₂ wherein H is a hydrogen atom and X is a halogen atom.

29. A method according to claim 28, wherein X represents a chlorine atom.

30. A method according to claim 27 further comprising generating said organomagnesium-coated metal oxide support material by combining a metal oxide support material with an organomagnesium compound, said organomagnesium compound bonding or complexing with the metal oxide support material.

31. A method according to claim 30, wherein said organomagnesium compound is according to the formula Mg(R^{b})₂, wherein each R^{b} independently represents a saturated or unsaturated, straight-chained or branched, cyclic, polycyclic, or fused hydrocarbon group having 1 to 10 carbon atoms.

32. A method according to claim 1, wherein said one or more catalytically active transition metal compounds are selected from the group consisting of catalytically active titanium and vanadium compounds.

33. A method according to claim 1, wherein said one or more catalytically active main group metal compounds are one or more catalytically active aluminum compounds.

34. A method according to claim 1, wherein at least some portion of the method is conducted in a hydrocarbon solvent.

35. A method according to claim 1, further comprising treating the polymerization catalyst with an external electron donor compound.

36. A method according to claim 35, wherein the external electron donor is selected from the group consisting of monofunctional and polyfunctional carboxylic acids, carboxylic anhydrides, carboxylic esters, ketones, ethers, alcohols, lactones, organophosphines, and siloxanes.

37. A method for polymerizing one or more olefins, the method comprising:
a) providing a polymerization catalyst produced according to a method comprising:
(I) providing a catalyst support material comprising a magnesium component bound or complexed to a metal oxide component, said magnesium component being either a magnesium(Y) component wherein Y is an alkoxide group or amido group, or an alcohol-adducted magnesium halide component, provided that when the magnesium component is the magnesium(Y) component then any magnesium halide component is excluded from the catalyst support material, and when the magnesium component is the alcohol-adducted magnesium halide component then a magnesium(Y) component and any organomagnesium component are excluded from the catalyst support material;
(II) reacting the magnesium component with one or more silane halide compounds to provide a modified catalyst support material by either:
(i) reacting the magnesium(Y) component with one or more silane halide compounds capable of converting the magnesium(Y) component to a magnesium halide component and capable of being converted to either one or more alkoxysilane electron donor compounds when Y is an alkoxide group or to one or more amidosilane electron donor compounds when Y is an amido group, or
(ii) reacting the alcohol-adducted magnesium halide component with one or more silane halide compounds capable of reacting with the adducted alcohol to form one or more alkoxysilane electron donor compounds,
wherein said modified catalyst support material comprises said one or more alkoxysilane electron donor compounds or said one or more amidosilane electron donor compounds and a magnesium halide component bound or complexed to the metal oxide component; and
(III) combining the modified catalyst support material of step (b) with one or more catalytically active transition metal compounds to provide a catalyst precursor; and
(IV) combining the catalyst precursor with one or more catalytically active main group metal compounds, thereby producing said polymerization catalyst; and
b) contacting the one or more olefins with said polymerization catalyst under polymerization reaction conditions, thereby producing a polymerization product of one or more olefins.

38. A method according to claim 37, wherein the one or more olefins include propene.

39. A method for producing a polymerization catalyst, the method comprising:
(a) providing a catalyst support material comprising a magnesium(alkoxide) component bound or complexed to a metal oxide component, wherein said catalyst support material excludes a magnesium halide component;
(b) reacting the magnesium(alkoxide) component with one or more silane halide compounds to provide a modified catalyst support comprising one or more alkoxysilane electron donor compounds and a magnesium halide component bound or complexed to the metal oxide component, wherein said silane halide compounds are capable of converting the magnesium(alkoxide) component to a magnesium halide component and capable of being converted to one or more alkoxysilane electron donor compounds by reaction with the magnesium(alkoxide) component;
(c) combining said modified catalyst support material with one or more catalytically active transition metal compounds to provide a catalyst precursor; and
(d) combining said catalyst precursor with one or more catalytically active main group metal compounds, thereby producing said polymerization catalyst.

40. A method for producing a polymerization catalyst, the method comprising:
(a) providing a catalyst support material comprising an alcohol-adducted magnesium halide component bound or complexed to a metal oxide component, wherein said catalyst support material excludes a magnesium(alkoxide) component and any organomagnesium component;
(b) reacting the alcohol-adducted magnesium halide component with one or more silane halide compounds to provide a modified catalyst support comprising one or more alkoxysilane electron donor compounds and a magnesium halide component bound or complexed to the metal oxide component, wherein said silane halide compounds are capable of reacting with the adducted alcohol to form one or more alkoxysilane electron donor compounds by an acid elimination pathway;
(c) combining said modified catalyst support material with one or more catalytically active transition metal compounds to provide a catalyst precursor; and
d) combining said catalyst precursor with one or more catalytically active main group metal compounds, thereby producing said polymerization catalyst.
